(19) United States
(12) Patent Application Publication
(10) Pub. No.: US 2025/0330594 A1
(43) Pub. Date: Oct. 23, 2025

(54) ADAPTIVE EXTRAPOLATION FILTER-BASED INTRA PREDICTION

(71) Applicant: Tencent America LLC, Palo Alto, CA (US)

(72) Inventors: Xiaozhong XU, State College, PA (US); Lien-fei CHEN, Palo Alto, CA (US); Roman CHERNYAK, Santa Clara, PA (US); Shan LIU, San Jose, CA (US)

(73) Assignee: Tencent America LLC, Palo Alto, CA (US)

(21) Appl. No.: 19/256,132

(22) Filed: Jun. 30, 2025

Related U.S. Application Data
(63) Continuation of application No. PCT/US2024/025607, filed on Apr. 20, 2024.
(60) Provisional application No. 63/461,180, filed on Apr. 21, 2023.

(51) Int. Cl. H04N 19/117; H04N 19/159; H04N 19/176

(52) U.S. Cl. CPC H04N 19/117; H04N 19/159; H04N 19/176

(57) ABSTRACT

Aspects of the disclosure includes methods and apparatuses for video decoding and video encoding and a method of processing visual media data. The apparatus for video decoding includes processing circuitry configured to: receive coded information indicating that a current block in a current picture is predicted according to an extrapolation filter-based intra prediction (EIP) mode; determine at least one of (i) one or more available template types from a set of template types and (ii) one or more available filter types from a set of filter types used in the EIP mode based on size information of the current block and at least one threshold value; determine a predicted value of a current sample in the current block according to the EIP mode with the at least one of (i) the one or more available template types and (ii) the one or more available filter types.

### RELATED APPLICATION

The present application is a continuation of International Application No. PCT/US2024/025607, filed on Apr. 20, 2024, which claims the benefit of priority to U.S. Provisional Application No. 63/461,180, “Adaptive Extrapolation Filter-Based Intra Prediction” filed on Apr. 21, 2023. The entire disclosures of the prior applications are hereby incorporated herein by reference in their entirety.

### TECHNICAL FIELD

The present disclosure describes aspects generally related to video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression can help transmit image/video data across different devices, storage and networks with minimal quality degradation. In some examples, video codec technology can compress video based on spatial and temporal redundancy. In an example, a video codec can use techniques referred to as intra prediction that can compress an image based on spatial redundancy. For example, the intra prediction can use reference data from the current picture under reconstruction for sample prediction. In another example, a video codec can use techniques referred to as inter prediction that can compress an image based on temporal redundancy. For example, the inter prediction can predict samples in a current picture from a previously reconstructed picture with motion compensation. The motion compensation can be indicated by a motion vector (MV).

### SUMMARY

Aspects of the disclosure include methods and apparatuses for video encoding/decoding.

In an aspect, a method of processing visual media data includes processing a bitstream of visual media data including a current picture according to a format rule. The bitstream includes at least one syntax element indicating that (i) a current block in the current picture is predicted according to an extrapolation filter-based intra prediction (EIP) mode and (ii) one or more available template types of the EIP mode is selected from a set of template types and one or more available filter types of the EIP mode is selected from a set of filter types based on first size information and second size information of the current block. The bitstream includes at least one high level syntax element associated with a level that is higher than the current block indicating a first threshold value and a second threshold value. The format rule specifies that the one or more available template types is determined based on the first size information of the current block and the first threshold value from the set of template types. The format rule specifies that the one or more available filter types is determined based on the second size information of the current block and the second threshold value from the set of filter types. The format rule specifies that a predicted value of a current sample in the current block is determined according to the EIP mode with the one or more available template types and the one or more available filter types.

In an example, the first size information or the second size information includes one of (i) a width w of the current block; (ii) a height h of the current block; (iii) an area w×h of the current block; (iv) a ratio between the width w and the height h indicating w/h. The set of template types includes a first template type TPL0 consisting of neighboring reconstructed samples above the current block and to the left of the current block, a second template type TPL1 consisting of neighboring reconstructed samples above the current block, and a third template type TPL2 consisting of neighboring reconstructed samples to the left of the current block. The set of filter types includes a first filter type F0 with a number of input samples in a vertical direction that is equal to a number of the input samples in a horizontal direction, a second filter type F1 with a number of input samples in the horizontal direction that is greater than a number of the input samples in the vertical direction, and a third filter type F2 with a number of input samples in the vertical direction that is greater than a number of the input samples in the horizontal direction.

In an aspect, a method for video encoding includes determining, based on first size information of a current block in a current picture and a first threshold value, one or more available template types from a set of template types of an extrapolation filter-based intra prediction (EIP) mode. The method includes determining, based on second size information of the current block and a second threshold value, one or more available filter types from a set of filter types of the EIP mode The method includes determining a predicted value of a current sample in the current block according to the EIP mode with the one or more available template types and the one or more available filter types. The method includes encoding, in a bitstream, the predicted value of the current sample and information indicating that the one or more available template types is determined from the set of template types and the one or more available filter types is determined from the set of filter types based on the first size information and the second size information.

In an example, the first threshold value and the second threshold value are predefined or encoded in a high level syntax associated with a level that is higher than the current block.

In an example, the first size information or the second size information includes one of (i) a width w of the current block; (ii) a height h of the current block; (iii) an area w×h of the current block; (iv) a ratio between the width w and the height h indicating w/h. The set of template types includes a first template type TPL0 consisting of neighboring reconstructed samples above the current block and to the left of the current block, a second template type TPL1 consisting of neighboring reconstructed samples above the current block, and a third template type TPL2 consisting of neighboring reconstructed samples to the left of the current block. The set of filter types includes a first filter type F0 with a number of input samples in a vertical direction that is equal to a number of the input samples in a horizontal direction, a second filter type F1 with a number of input samples in the horizontal direction that is greater than a number of the input samples in the vertical direction, and a third filter type F2 with a number of input samples in the vertical direction that is greater than a number of the input samples in the horizontal direction.

According to an aspect of the disclosure, an apparatus for video decoding includes processing circuitry. The processing circuitry is configured to receive coded information indicating that a current block in a current picture is predicted according to an extrapolation filter-based intra prediction (EIP) mode. The processing circuitry is configured to determine at least one of (i) one or more available template types from a set of template types and (ii) one or more available filter types from a set of filter types used in the EIP mode based on size information of the current block and at least one threshold value. The processing circuitry is configured to determine a predicted value of a current sample in the current block according to the EIP mode with the at least one of (i) the one or more available template types and (ii) the one or more available filter types; and reconstruct the current sample based on the predicted value of the current sample.

In an example, the at least one of (i) the one or more available template types and (ii) the one or more available filter types includes (a) the one or more available template types and (b) the one or more available filter types of the EIP mode. The size information includes first size information and second size information. The at least one threshold value includes a first threshold value and a second threshold value. The processing circuitry is configured to determine the one or more available template types based on the first size information of the current block and the first threshold value; and determine the one or more available filter types based on the second size information of the current block and the second threshold value.

In an example, the at least one threshold value is predefined or signaled in a high level syntax associated with a level that is higher than the current block.

In an example, the size information includes one of (i) a width w of the current block; (ii) a height h of the current block; (iii) an area w×h of the current block; (iv) a ratio between the width w and the height h indicating w/h of the current block, and the set of template types includes a first template type TPL0 consisting of neighboring reconstructed samples above the current block and to the left of the current block, a second template type TPL1 consisting of neighboring reconstructed samples above the current block, and a third template type TPL2 consisting of neighboring reconstructed samples to the left of the current block.

In an example, the size information includes the width w of the current block. The at least one threshold value includes a threshold value. The processing circuitry is configured to determine the one or more available template types based on one of: (i) the one or more available template types consists of {TPL1} when w is greater than or equal to the threshold value; (ii) the one or more available template types consists of {TPL0} when w is greater than or equal to the threshold value; (iii) the one or more available template types consists of {TPL0, TPL1} when w is greater than or equal to the threshold value; (iv) the one or more available template types consists of {TPL0} when w is less than or equal to the threshold value; and (v) the one or more available template types consists of {TPL0, TPL2} when w is less than or equal to the threshold value.

In an example, the size information includes the height h of the current block, and the at least one threshold value includes a threshold value. The processing circuitry is configured to determine the one or more available template types based on one of: (i) the one or more available template types consists of {TPL2}, when h is greater than or equal to the threshold value; (ii) the one or more available template types consists of {TPL0} when h is greater than or equal to the threshold value; (iii) the one or more available template types consists of {TPL0, TPL2} when h is greater than or equal to the threshold value; (iv) the one or more available template types consists of {TPL0} when h is less than or equal to the threshold value; and (v) the one or more available template types consists of {TPL0, TPL1} when h is less than or equal to the threshold value.

In an example, the size information includes the area w×h of the current block, and the at least one threshold value includes a threshold value. The processing circuitry is configured to determine the one or more available template types based on one of: (i) the one or more available template types consists of {TPL0} when w×h is greater than or equal to the threshold value; and (ii) the one or more available template types consists of {TPL0} when w×h is less than or equal to the threshold value.

In an example, the size information includes the ratio between the width w and the height h indicating w/h, and the at least one threshold value includes a threshold value. The processing circuitry is configured to determine the one or more available template types based on one of: (i) the one or more available template types consists of {TPL1} when w/h is greater than or equal to the threshold value; (ii) the one or more available template types consists of {TPL0, TPL1} when w/h is greater than or equal to the threshold value; (iii) the one or more available template types consists of {TPL0, TPL2} when w/h is less than or equal to the threshold value; and (iv) the one or more available template types consists of {TPL0, TPL2} when w/h is less than or equal to the threshold value.

In an example, the size information includes one of (i) a width w of the current block; (ii) a height h of the current block; (iii) an area w×h of the current block; (iv) a ratio between the width w and the height h indicating w/h. The set of filter types includes a first filter type F0 with a number of input samples in a vertical direction that is equal to a number of the input samples in a horizontal direction, a second filter type F1 with a number of input samples in the horizontal direction that is greater than a number of the input samples in the vertical direction, and a third filter type F2 with a number of input samples in the vertical direction that is greater than a number of the input samples in the horizontal direction.

In an example, the size information includes the width w of the current block, and the at least one threshold value includes a threshold value. The processing circuitry is configured to determine the one or more available filter types based on one of: (i) the one or more available filter types consists of {F1} when w is greater than or equal to the threshold value; (ii) the one or more available filter types consists of {F0} when w is greater than or equal to the threshold value; (iii) the one or more available filter types consists of {F0, F1} when w is greater than or equal to the threshold value; (iv) the one or more available filter types consists of {F0} when w is less than or equal to the threshold value; and (v) the one or more available filter types consists of {F0, F2} when w is less than or equal to the threshold value.

In an example, the size information includes the height h of the current block, and the at least one threshold value includes a threshold value. The processing circuitry is configured to determine the one or more available filter types based on one of: (i) the one or more available filter types consists of {F2} when h is greater than or equal to the threshold value; (ii) the one or more available filter types consists of {F0}, when h is greater than or equal to the threshold value; (iii) the one or more available filter types consists of {F0, F2}, when h is greater than or equal to the threshold value; (iv) the one or more available filter types consists of {F0} when h is less than or equal to the threshold value; and (v) the one or more available filter types consists of {F0, F1} when h is less than or equal to the threshold value.

In an example, the size information includes the area w×h of the current block, and the at least one threshold value includes a threshold value. The processing circuitry is configured to determine the one or more available filter types based on one of: (i) the one or more available filter types consists of {F0} when w×h is greater than or equal to the threshold value; and (ii) the one or more available filter types consists of {F0} when w×h is less than or equal to the threshold value.

In an example, the size information includes the ratio between the width w and the height h indicating w/h, and the at least one threshold value includes a threshold value. The processing circuitry is configured to determine the one or more available filter types based on one of: (i) the one or more available filter types consists of {F1} when w/h is greater than or equal to the threshold value; (ii) the one or more available filter types consists of {F0, F1} when w/h is greater than or equal to the threshold value; (iii) the one or more available filter types consists of {F0, F2} when w/h is less than or equal to the threshold value; and (iv) the one or more available filter types consists of {F0, F2} when w/h is less than or equal to the threshold value.

In an example, when the at least one of (i) the one or more available template types and (ii) the one or more available filter types consists of the one or more available template types, the processing circuitry is configured to: determine, using second size information of the current block and at least one second threshold value, context modeling used in context coding of a filter type selected for the current block; decode the filter type from the coded information based on the determined context modeling; and determine the predicted value of the current sample using the EIP mode with the one or more available template types and the decoded filter type.

In an example, when the at least one of (i) the one or more available template types and (ii) the one or more available filter types consists of the one or more available filter types, the processing circuitry is configured to: determine, using second size information of the current block and at least one second threshold value, context modeling used in context coding of a template type selected for the current block; decode the template type from the coded information based on the determined context modeling; and determine the predicted value of the current sample using the EIP mode with the decoded template type and the one or more available filter types.

In an example, the at least one second threshold value is predefined or signaled in a high level syntax associated with a level that is higher than the current block.

In an example, the second size information used to determine the context modeling includes one of (i) a width w of the current block; (ii) a height h of the current block; (iii) an area w×h of the current block; (iv) a ratio between the width w and the height h indicating w/h, and the context modeling is one of a first context set and a second context set.

Aspects of the disclosure also provide an apparatus for video encoding. The apparatus for video encoding including processing circuitry configured to implement any of the described methods for video encoding.

Aspects of the disclosure also provide a method for video decoding. The method including any of the methods implemented by the apparatus for video decoding.

Aspects of the disclosure also provide a non-transitory computer-readable medium storing instructions which, when executed by a computer, cause the computer to perform any of the described methods for video decoding/encoding.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an example of a block diagram of a communication system (100).

FIG. 2 is a schematic illustration of an example of a block diagram of a decoder.

FIG. 3 is a schematic illustration of an example of a block diagram of an encoder.

FIG. 4 shows an example of intra prediction modes according to an aspect of the disclosure.

FIG. 5 shows an example of a matrix weighted intra prediction process according to an aspect of the disclosure.

FIG. 6 shows an example of a spatial component of a convolutional filter according to an aspect of the disclosure.

FIG. 7 shows an example of a reference area used to derive filter coefficients according to an aspect of the disclosure.

FIG. 8 shows examples of spatial samples used for a gradient and location based convolutional cross-component model (GL-CCCM) according to an aspect of the disclosure.

FIG. 9 shows examples of three types of reconstructed areas (e.g., three template types) according to an aspect of the disclosure.

FIG. 10 shows examples of three types of filter shapes according to an aspect of the disclosure.

FIGS. 11-13 show an example of predicting samples in a current block based on an extrapolation filter-based intra prediction (EIP) mode according to an aspect of the disclosure.

FIG. 14 shows an example of a picture divided into CTUs according to an aspect of the disclosure.

FIG. 15 shows an example of multi-type tree splitting modes according to an aspect of the disclosure.

FIG. 16 shows an example of a signaling mechanism of partition splitting information in quadtree with nested multi-type tree coding tree structure according to an aspect of the disclosure.

FIG. 17 shows an example of a CTU divided into multiple CUs with a quadtree and nested multi-type tree coding block structure according to an aspect of the disclosure.

FIG. 18 shows a flow chart outlining a decoding process according to some aspects of the disclosure.

FIG. 19 shows a flow chart outlining an encoding process according to some aspects of the disclosure.

FIG. 20 is a schematic illustration of a computer system in accordance with an aspect.

### DETAILED DESCRIPTION

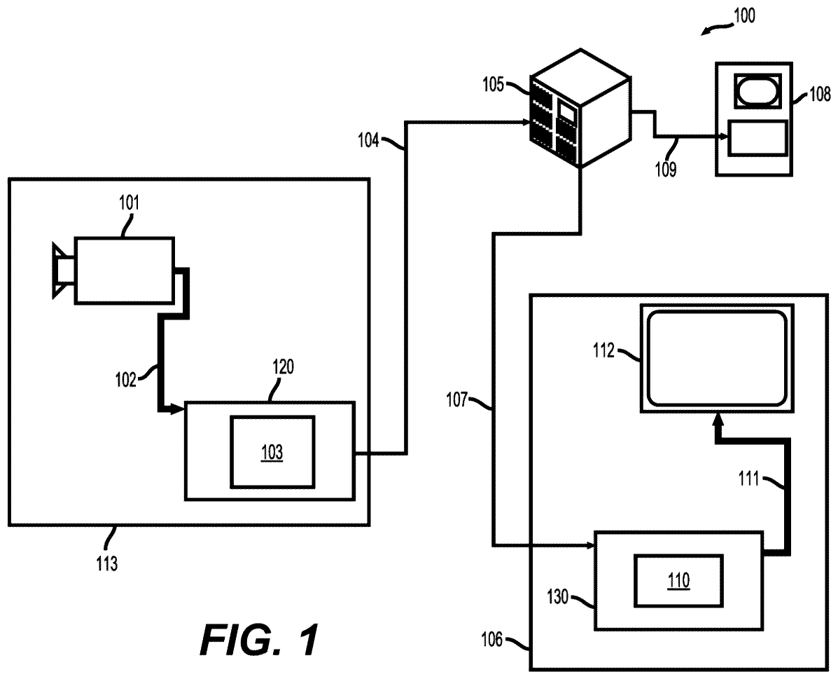

FIG. 1 shows a block diagram of a video processing system (100) in some examples. The video processing system (100) is an example of an application for the disclosed subject matter, a video encoder and a video decoder in a streaming environment. The disclosed subject matter can be equally applicable to other video enabled applications, including, for example, video conferencing, digital TV, streaming services, storing of compressed video on digital media including CD, DVD, memory stick and the like, and so on.

The video processing system (100) includes a capture subsystem (113), that can include a video source (101), for example a digital camera, creating for example a stream of video pictures (102) that are uncompressed. In an example, the stream of video pictures (102) includes samples that are taken by the digital camera. The stream of video pictures (102), depicted as a bold line to emphasize a high data volume when compared to encoded video data (104) (or coded video bitstreams), can be processed by an electronic device (120) that includes a video encoder (103) coupled to the video source (101). The video encoder (103) can include hardware, software, or a combination thereof to enable or implement aspects of the disclosed subject matter as described in more detail below. The encoded video data (104) (or encoded video bitstream), depicted as a thin line to emphasize the lower data volume when compared to the stream of video pictures (102), can be stored on a streaming server (105) for future use. One or more streaming client subsystems, such as client subsystems (106) and (108) in FIG. 1 can access the streaming server (105) to retrieve copies (107) and (109) of the encoded video data (104). A client subsystem (106) can include a video decoder (110), for example, in an electronic device (130). The video decoder (110) decodes the incoming copy (107) of the encoded video data and creates an outgoing stream of video pictures (111) that can be rendered on a display (112) (e.g., display screen) or other rendering device (not depicted). In some streaming systems, the encoded video data (104), (107), and (109) (e.g., video bitstreams) can be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (120) and (130) can include other components (not shown). For example, the electronic device (120) can include a video decoder (not shown) and the electronic device (130) can include a video encoder (not shown) as well.

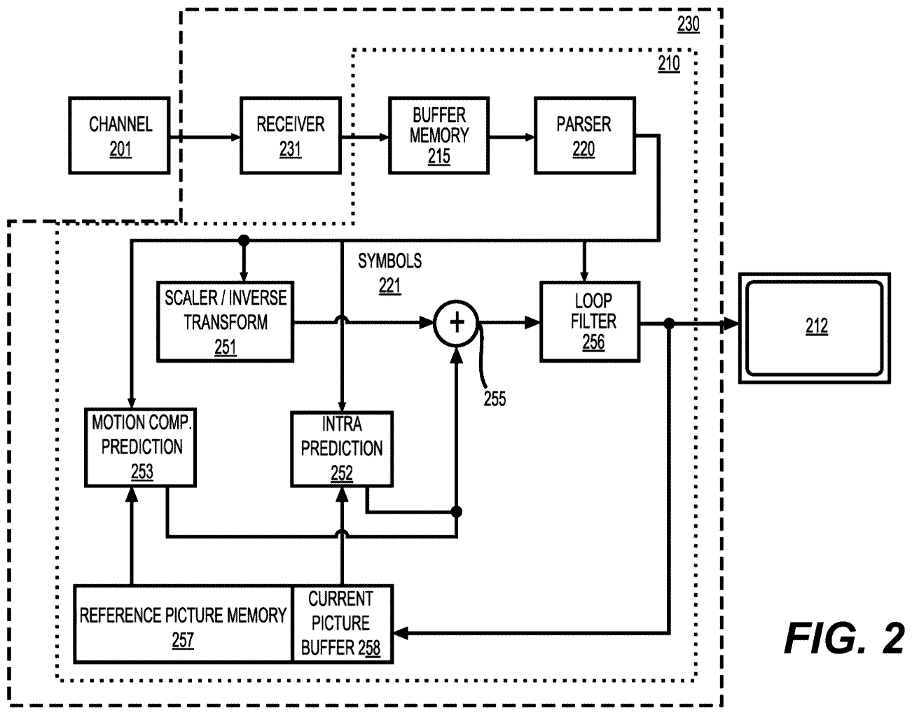

FIG. 2 shows an example of a block diagram of a video decoder (210). The video decoder (210) can be included in an electronic device (230). The electronic device (230) can include a receiver (231) (e.g., receiving circuitry). The video decoder (210) can be used in the place of the video decoder (110) in the FIG. 1 example.

The receiver (231) may receive one or more coded video sequences, included in a bitstream for example, to be decoded by the video decoder (210). In an aspect, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it can be outside of the video decoder (210) (not depicted). In still others, there can be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or can be small. For use on best effort packet networks such as the Internet, the buffer memory (215) may be required, can be comparatively large and can be advantageously of adaptive size, and may at least partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but can be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) can involve multiple different units depending on the type of the coded video picture or parts thereof (such as: inter and intra picture, inter and intra block), and other factors. Which units are involved, and how, can be controlled by subgroup control information parsed from the coded video sequence by the parser (220). The flow of such subgroup control information between the parser (220) and the multiple units below is not depicted for clarity.

Beyond the functional blocks already mentioned, the video decoder (210) can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) can output blocks comprising sample values, that can be input into aggregator (255).

In some cases, the output samples of the scaler/inverse transform unit (251) can pertain to an intra coded block. The intra coded block is a block that is not using predictive information from previously reconstructed pictures, but can use predictive information from previously reconstructed parts of the current picture. Such predictive information can be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) can pertain to an inter coded, and potentially motion compensated, block. In such a case, a motion compensation prediction unit (253) can access reference picture memory (257) to fetch samples used for prediction. After motion compensating the fetched samples in accordance with the symbols (221) pertaining to the block, these samples can be added by the aggregator (255) to the output of the scaler/inverse transform unit (251) (in this case called the residual samples or residual signal) so as to generate output sample information. The addresses within the reference picture memory (257) from where the motion compensation prediction unit (253) fetches prediction samples can be controlled by motion vectors, available to the motion compensation prediction unit (253) in the form of symbols (221) that can have, for example X, Y, and reference picture components. Motion compensation also can include interpolation of sample values as fetched from the reference picture memory (257) when sub-sample exact motion vectors are in use, motion vector prediction mechanisms, and so forth.

The output samples of the aggregator (255) can be subject to various loop filtering techniques in the loop filter unit (256). Video compression technologies can include in-loop filter technologies that are controlled by parameters included in the coded video sequence (also referred to as coded video bitstream) and made available to the loop filter unit (256) as symbols (221) from the parser (220). Video compression can also be responsive to meta-information obtained during the decoding of previous (in decoding order) parts of the coded picture or coded video sequence, as well as responsive to previously reconstructed and loop-filtered sample values.

The output of the loop filter unit (256) can be a sample stream that can be output to the render device (212) as well as stored in the reference picture memory (257) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (220)), the current picture buffer (258) can become a part of the reference picture memory (257), and a fresh current picture buffer can be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an aspect, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

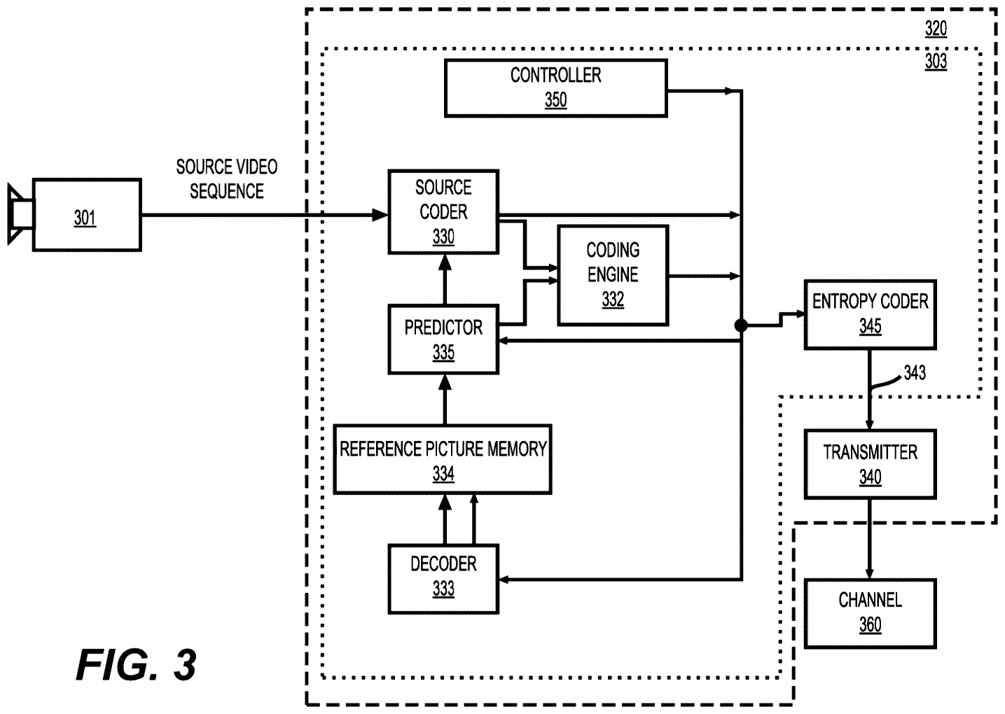

FIG. 3 shows an example of a block diagram of a video encoder (303). The video encoder (303) is included in an electronic device (320). The electronic device (320) includes a transmitter (340) (e.g., transmitting circuitry). The video encoder (303) can be used in the place of the video encoder (103) in the FIG. 1 example.

The video encoder (303) may receive video samples from a video source (301) (that is not part of the electronic device (320) in the FIG. 3 example) that may capture video image(s) to be coded by the video encoder (303). In another example, the video source (301) is a part of the electronic device (320).

The video source (301) may provide the source video sequence to be coded by the video encoder (303) in the form of a digital video sample stream that can be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel can include one or more samples depending on the sampling structure, color space, etc. in use. The description below focuses on samples.

According to an aspect, the video encoder (303) may code and compress the pictures of the source video sequence into a coded video sequence (343) in real time or under any other time constraints as required. Enforcing appropriate coding speed is one function of a controller (350). In some aspects, the controller (350) controls other functional units as described below and is functionally coupled to the other functional units. The coupling is not depicted for clarity. Parameters set by the controller (350) can include rate control related parameters (picture skip, quantizer, lambda value of rate-distortion optimization techniques, . . . ), picture size, group of pictures (GOP) layout, maximum motion vector search range, and so forth. The controller (350) can be configured to have other suitable functions that pertain to the video encoder (303) optimized for a certain system design.

In some aspects, the video encoder (303) is configured to operate in a coding loop. As an oversimplified description, in an example, the coding loop can include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (333) can be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) can be lossless, the entropy decoding parts of the video decoder (210), including the buffer memory (215), and parser (220) may not be fully implemented in the local decoder (333).

In an aspect, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as candidate reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an aspect, the transmitter (340) may transmit additional data with the encoded video. The source coder (330) may include such data as part of the coded video sequence. Additional data may include temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

In some aspects, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some aspects of the disclosure, predictions, such as inter-picture predictions and intra-picture predictions, are performed in the unit of blocks. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU can be recursively quadtree split into one or multiple coding units (CUs). For example, a CTU of 64×64 pixels can be split into one CU of 64×64 pixels, or 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an aspect, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the video encoders (103) and (303), and the video decoders (110) and (210) can be implemented using any suitable technique. In an aspect, the video encoders (103) and (303) and the video decoders (110) and (210) can be implemented using one or more integrated circuits. In another aspect, the video encoders (103) and (303), and the video decoders (110) and (210) can be implemented using one or more processors that execute software instructions.

Intra prediction may be used, such as in VVC. Advanced intra prediction techniques such as used in VVC may include the DC and planar modes similar to HEVC, additional finer-granularity angular prediction with more angles compared to HEVC (e.g., a number of angular prediction modes may be used increased from 33 in HEVC to 93), additional matrix-based prediction modes for a luma component, and cross-component prediction modes for a chroma component. The new (e.g., additional) intra coding tools such as used in VVC may include: 67 intra mode with wide angles mode extension; block size and mode dependent 4 tap interpolation filter; position dependent intra prediction combination (PDPC); cross component linear model (CCLM) intra prediction; multi-reference line (MRL) intra prediction; intra sub-partitions (ISP); and weighted intra prediction with matrix multiplication.

In an example, intra mode coding with 67 intra prediction modes is described as follows. To capture the arbitrary edge directions presented in a natural video, the number of directional intra modes such as used in VVC is extended from 33 as used in HEVC to 65. The new directional modes that are not in HEVC are depicted as dotted arrows in FIG. 4, and the planar and DC modes remain the same. The denser directional intra prediction modes may apply for various block sizes (e.g., all block sizes) and for both luma and chroma intra predictions. In an example, such as in VVC, multiple conventional angular intra prediction modes are adaptively replaced with wide-angle intra prediction modes for the non-square blocks. In an example, the conventional angular intra prediction modes may include the angular intra prediction modes used in HEVC.

In an example, such as in HEVC, an intra-coded block (e.g., every intra-coded block) has a square shape and the length of each side may a power of 2. Thus, no division operations are required to generate an intra-predictor using the DC mode. In an example, such as in VVC, blocks can have a rectangular shape. In some examples, a division operation per block may be used (e.g., may be required). To avoid division operations for the DC prediction, in some examples, only the longer side is used to compute the average for non-square blocks.

An example of intra mode coding is described as follows. To keep the complexity of the most probable mode (MPM) list generation low, an intra mode coding method with 6 MPMs may be used by considering two available neighboring intra modes. The following three aspects may be considered to construct the MPM list: default intra modes; neighboring intra modes; and derived intra modes. In an example, a unified 6-MPM list is used for intra blocks irrespective of whether MRL and ISP coding tools are applied or not. The MPM list may be constructed based on intra modes of the left and above neighboring blocks of the current block.

In an example, a 4-tap interpolation filter and reference sample smoothing may be applied. Four-tap intra interpolation filters (IF) may be utilized to improve the directional intra prediction accuracy. In HEVC, a two-tap linear interpolation filter has been used to generate the intra prediction block in the directional prediction modes (e.g., excluding Planar and DC predictors). In VVC, in some examples, the two sets of 4-tap IFs may replace lower precision linear interpolation as in HEVC, where one is a DCT-based interpolation filter (DCTIF) and the other one is a 4-tap smoothing interpolation filter (SIF). The DCTIF may be constructed in the same way as the one used for chroma component motion compensation in both HEVC and VVC. The SIF may be obtained by convolving the 2-tap linear interpolation filter with a [1 2 1]/4 filter.

Depending on the intra prediction mode, the following reference samples processing may be performed in some examples:
The directional intra-prediction mode is classified into one of the following groups:
   Group A: vertical or horizontal modes (HOR_IDX, VER_IDX),
   Group B: directional modes that represent non-fractional angles (−14, −12, −10, −6, 2, 34, 66, 72, 76, 78, 80) and Planar mode,
   Group C: remaining directional modes;
If the directional intra-prediction mode is classified as belonging to the group A, then no filters are applied to reference samples to generate predicted samples;
Otherwise, if a mode falls into the group B and the mode is a directional mode, and all of following conditions are true, then a [1, 2, 1] reference sample filter may be applied (depending on the mode dependent intra smoothing (MDIS) condition) to reference samples to further copy the filtered values into an intra predictor according to the selected direction, but no interpolation filters are applied:
   refIdx is equal to 0 (no MRL)
TU size is greater than 32
Luma
No ISP block
Otherwise, if a mode is classified as belonging to the group C, an MRL index is equal to 0, and the current block is not an ISP block, then only an intra reference sample interpolation filter is applied to reference samples to generate a predicted sample that falls into a fractional or integer position between reference samples according to a selected direction (no reference sample filtering is performed). The interpolation filter type is determined as follows:
   Set minDistVerHor equal to Min(Abs(predModeIntra−50), Abs(predModeIntra−18))

$$Set nTbS equal to ( Log 2 ( W ) + Log 2 ( H ) ) ≫ 1$$

Set intraHorVerDistThres[nTbS] as specified below:

| | nTbS = 2 | nTbS = 3 | nTbS = 4 | nTbS = 5 | nTbS = 6 | nTbS = 7 |
|---|---|---|---|---|---|---|
| intraHorVerDistThres | 24 | 14 | 2 | 0 | 0 | 0 |
| [nTbS] | | | | | | |

If minDistVerHor is greater than intraHorVerDistThres[nTbS], SIF is used for the interpolation
Otherwise, DCTIF is used for the interpolation.

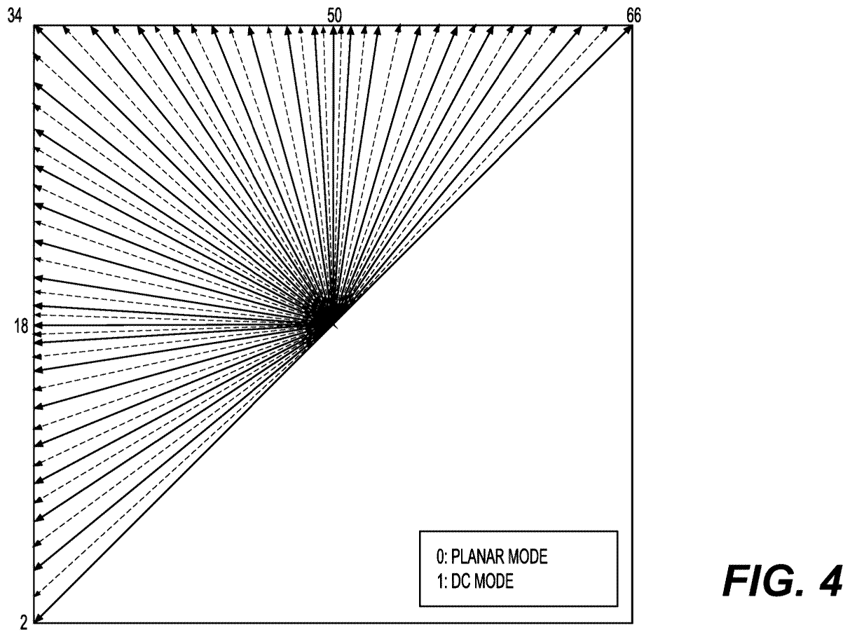

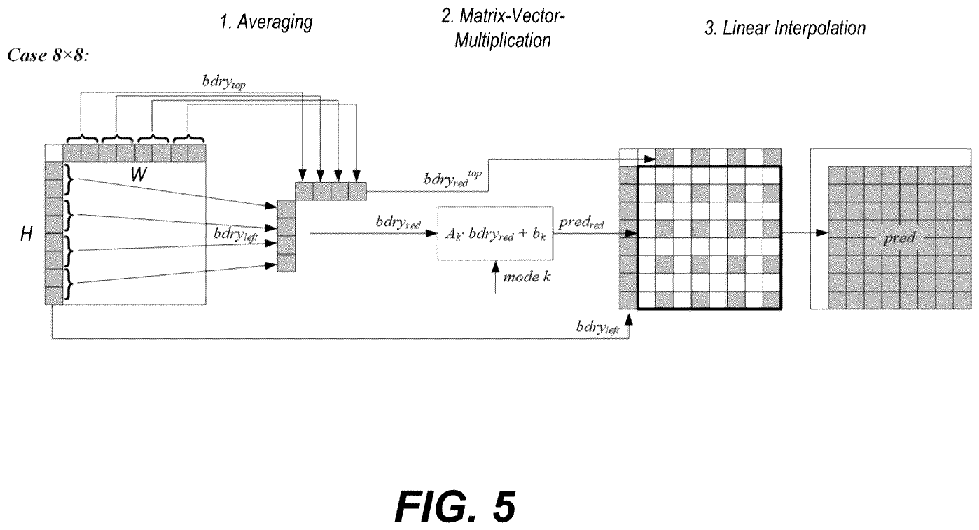

Matrix weighted Intra Prediction (MIP) may be used. The MIP method is a newly added intra prediction technique into VVC. For predicting the samples of a rectangular block of width and height, the MIP mode may take one line of H reconstructed neighboring boundary samples to the left of the block and one line of reconstructed neighboring boundary samples above the block as input. If the reconstructed samples are unavailable, they may be generated as done in the conventional intra prediction. The generation of the prediction signal may be based on the following three steps, including averaging, matrix vector multiplication, and linear interpolation as shown in FIG. 5.

Convolutional cross-component intra prediction model may be used such as in ECM. A convolutional cross-component model (CCCM) may be applied to predict chroma samples from reconstructed luma samples, such as in a similar manner as the current CCLM modes. As with CCLM, the reconstructed luma samples may be down-sampled to match the lower resolution chroma grid when chroma sub-sampling is used. Similar to CCLM, top, left, or top and left reference samples may be used as templates for model derivation.

Similar to CCLM, there may be an option of using a single model or multi-model variant of CCCM. The multi-model variant may use two models, one model derived for samples above the average luma reference value and another model for the rest of the samples (following the spirit of the CCLM design). Multi-model CCCM mode can be selected for PUs which, for example, have at least 128 reference samples available.

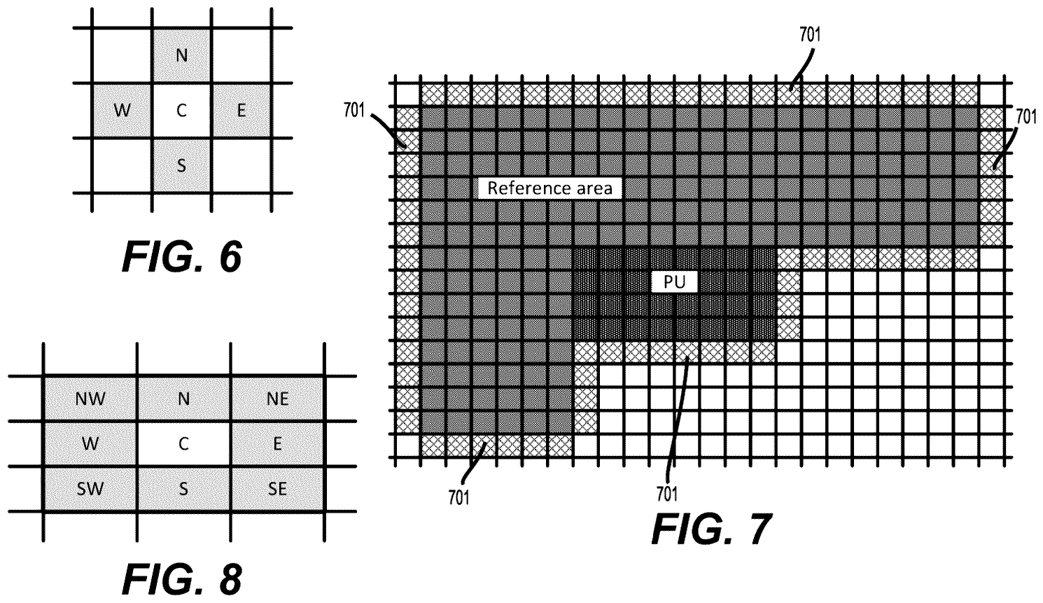

A convolutional filter, such as a convolutional 7-tap filter may include, or consist of, a 5-tap plus sign shape spatial component, a nonlinear term, and a bias term. The input to the spatial 5-tap component of the filter may include, or consist of, a center (C) luma sample which is collocated with the chroma sample to be predicted and its above or north (N), below or south (S), left or west (W) and right or east (E) neighbors as illustrated in FIG. 6.

The nonlinear term NP may be represented as power of two of the center luma sample C and may be scaled to the sample value range of the content such as described in Eq. 1.

$$NP = ( {C}^{2} + midVal ) ≫ bitDepth \qquad Eq . 1$$

That is, for 10-bit content the nonlinear_termNP may be calculated using Eq. 2.

$$NP = ( {C}^{2} + 512 ) ≫ 10 \qquad Eq . 2$$

The middle value (midVal) is 2¹⁰/2, which is 512.

The bias term B may represent a scalar offset between the input and output (e.g., similar to the offset term in CCLM) and may be set to a middle chroma value (e.g., 512 for 10-bit content).

An output of the filter may be calculated as a convolution between the filter coefficients ci and the input values and may be clipped to the range of valid chroma samples using Eq. 3.

$$predChromaVal = {c}_{0} C + {c}_{1} N + {c}_{2} S + {c}_{3} E + {c}_{4} W + {c}_{5} P + {c}_{6} B \qquad Eq . 3$$

The filter coefficients ci may be calculated, for example, by minimizing an error (e.g., a mean squared error (MSE)) between predicted and reconstructed chroma samples in the reference area. FIG. 7 shows an example of the reference area (with its paddings) used to derive the filter coefficients according to an aspect of the disclosure. The reference area may include, or consist of, 6 lines of chroma samples above and to the left of the PU. The reference area may extend one PU width to the right and one PU height below the PU boundaries. The area may be adjusted to include only available samples. The extensions (701) to the area may be used to support the “side samples” of the plus shaped spatial filter and are padded when in unavailable areas.

The MSE minimization may be performed by calculating an autocorrelation matrix for the luma input and a cross-correlation vector between the luma input and chroma output. The autocorrelation matrix may be LDL decomposed and the final filter coefficients may be calculated using back-substitution. The process may follow roughly the calculation of the ALF filter coefficients such as used in ECM, however LDL decomposition is used as an example instead of Cholesky decomposition, for example, to avoid using square root operations.

The autocorrelation matrix may be calculated using the reconstructed values of luma and chroma samples. The luma and chroma samples may be in a full range (e.g., between 0 and 1023 for 10-bit content) resulting in relatively large values in the autocorrelation matrix. This may use high bit depth operation during the model parameters calculation. Fixed offsets may be removed from luma and chroma samples in each PU for each model. This may reduce the magnitudes of the values used in the model creation and allow reducing the precision for the fixed-point arithmetic. As a result, in some examples, 16-bit decimal precision may be used instead of the 22-bit precision of the original CCCM implementation.

In some examples, reference sample values just outside of the top-left corner of the PU may be used as the offsets (offsetLuma, offsetCb and offsetCr) for simplicity. The samples values used in both model creation and final prediction (e.g., luma and chroma in the reference area, and luma in the current PU) may be reduced by the fixed values, as follows: C′=C−offsetLuma; N′=N−offsetLuma; S′=S−offsetLuma; E′=E−offsetLuma; W′=W−offsetLuma; P′=nonLinear(C′); B=midValue=1<<(bitDepth−1); and the chroma value be predicted using Eq. 4, where offsetChroma is equal to offsetCr and offsetCb for Cr and Cb components, respectively.

$$predChromaVal = {c}_{0} {C}^{′} + {c}_{1} {N}^{′} + {c}_{2} {S}^{′} + {c}_{3} {E}^{′} + {c}_{4} {W}^{′} + {c}_{5} {P}^{′} + {c}_{6} B + offsetChroma \qquad Eq . 4$$

In an example, to avoid any additional sample level operations, the luma offset is removed during the luma reference sample interpolation. This can be done, for example, by substituting the rounding term used in the luma reference sample interpolation with an updated offset including both the rounding term and the offsetLuma. The chroma offset can be removed by deducting the chroma offset directly from the reference chroma samples. As an alternative way, impact of the chroma offset can be removed from the cross-component vector giving identical result. In order to add the chroma offset back to the output of the convolutional prediction operation, the chroma offset may be added to the bias term of the convolutional model.

The process of CCCM model parameter calculation may use division operations. In some examples, division operations may not be implementation friendly. The division operation may be replaced with a multiplication (with a scale factor) and shift operation, where a scale factor and a number of shifts may be calculated based on a denominator, for example, similar to the method used in calculation of CCLM parameters.

A gradient and location based convolutional cross-component model (GL-CCCM) may map luma values into chroma values using a filter with inputs including (e.g., consisting of) one spatial luma sample, two gradient values, two location information, a nonlinear term, and a bias term. The GL-CCCM method may use gradient and location information instead of the 4 spatial neighbor samples used in the CCCM filter. The GL-CCCM filter used for the prediction may be described using Eq. 5.

$$predChromaVal = {c}_{0} C + {c}_{1} {G}_{y} + {c}_{2} {G}_{x} + {c}_{3} Y + {c}_{4} X + {c}_{5} P + {c}_{6} B \qquad Eq . 5$$

FIG. 8 shows examples of spatial samples used for the GL-CCCM according to an aspect of the disclosure. Gy and Gx are the vertical and horizontal gradients, respectively, and are calculated using Eq. 6.

$${G}_{y} = ( 2 N + NW + NE ) - ( 2 S + SW + SE ) \qquad Eq . 6$$

$${G}_{x} = ( 2 W + NW + SW ) - ( 2 E + NE + SE )$$

The Y and X are the spatial coordinates of the center luma sample.

The rest of the parameters may be the same as a CCCM tool. The reference area for the parameter calculation may be the same as a CCCM method.

The usage of the GL-CCCM mode may be signaled with a flag, such as a CABAC coded PU level flag. The GL-CCCM mode may be considered a sub-mode of CCCM in terms of signaling, for example, the GL-CCCM flag is only signaled if the original CCCM flag is true.

Similar to the CCCM, in some examples, the GL-CCCM tool has 6 modes for calculating the parameters: a single-model GL-CCCM from above and left templates; a single-model GL-CCCM from the above template; a single-model GL-CCCM from the left template; a multi-model GL-CCCM from the above and left templates; a multi-model GL-CCCM from the above template; and a multi-model GL-CCCM from the left template. The encoder may perform a search (e.g., a sum of absolute transformed differences (SATD) search) for the 6 GL-CCCM modes along with the existing CCCM modes to find the best candidates for full rate-distortion (RD) tests.

An extrapolation filter-based intra prediction (EIP) mode may be used. In an example, an equal probability (EP) bin is used to encode the EIP mode. In an example, the EIP mode includes two steps. In a first step, the extrapolation filter coefficients may be obtained from the neighboring reconstructed pixels (or samples) of the current block with a pre-determined template. In a second step, the extrapolation may generate a predicted value position by position, for example, from a top-left sample to a bottom-right sample within the current block.

In an example, a mean value, a min value, and a max value may be searched as follows. Similar to the CCCM mode, in the EIP mode, a mean value may be removed when feeding the inputs to the EIP filter. The value of the DC mode for the current block may be used as the mean value for EIP prediction. The min value and the max value may be searched from reconstructed pixels in the reconstructed area with, for example, thirteen columns and thirteen rows.

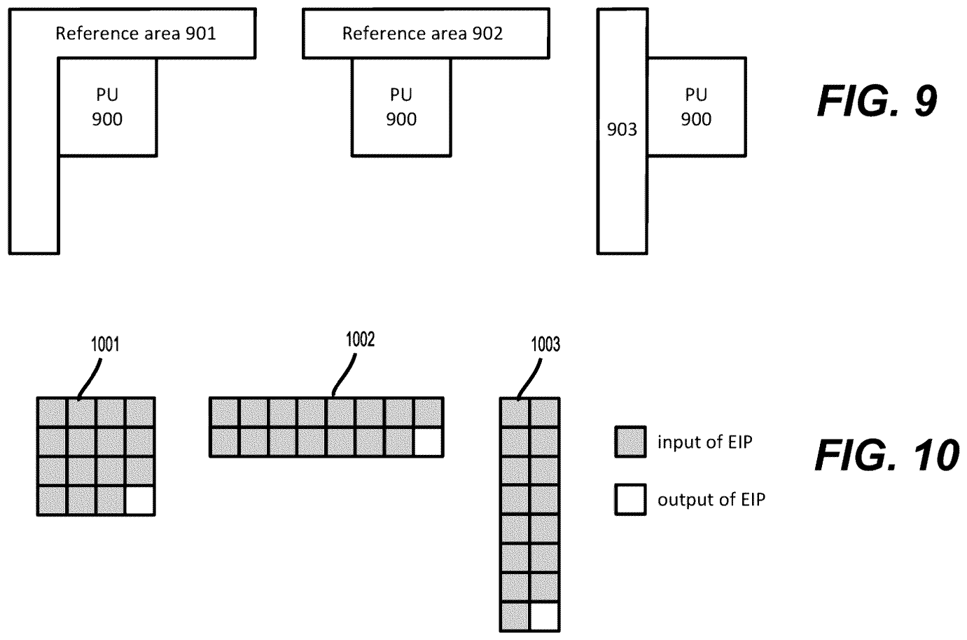

Filter coefficients may be calculated as below. FIG. 9 shows examples of the defined three types of reconstructed areas according to an aspect of the disclosure. The three types of reconstructed areas or the reference areas (901)-(903) may include thirteen columns or rows of reconstructed pixels. FIG. 10 shows examples of the defined three types of filter shapes according to an aspect of the disclosure. The three types of filter shapes (1001)-(1003) may include fifteen inputs (also referred to as input samples) and generate one output. When the current block uses the EIP mode for prediction, the decoder may decode the relevant syntax elements to determine the selected type of reconstructed area and filter shape for the current block.

The selected filter may slide in the selected reconstructed area with a one-pixel step to collect input samples and output samples of the EIP mode. The auto-correlation matrix and cross-correlation vector may be constructed while removing the mean value from input samples and output samples. Then, the EIP coefficients may be obtained by the same method in CCCM.

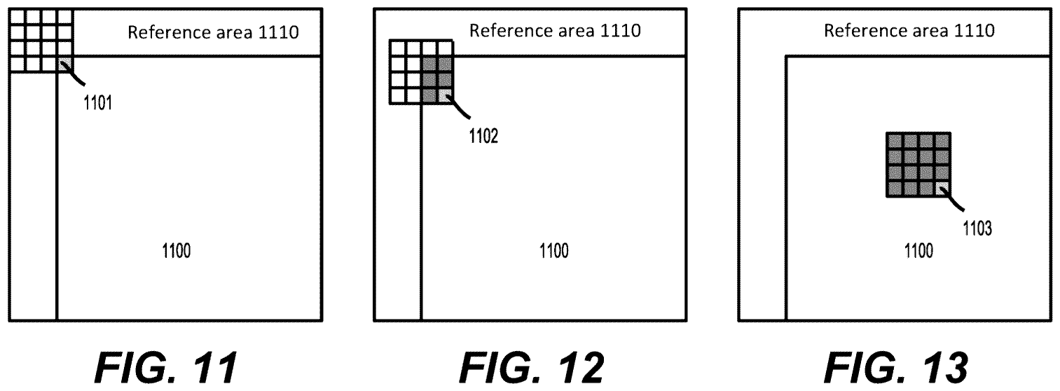

FIGS. 11-13 show an example of predicting samples in a current block (1100) based on the EIP mode according to an aspect of the disclosure. The EIP mode may predict samples in the current block position by position.

Referring to FIG. 11, all inputs to EIP are reconstructed samples. For the position (e.g., a top-left position) (1101) located at the top-left of the current block, the inputs to the EIP filter are reconstructed samples, for example, the reconstructed reference samples in the reference area (1110). Referring to FIG. 12, for the positions located along the boundaries of the current block (1100), partial inputs to the EIP filter are reference samples that are already reconstructed in the reference area (1110), and partial inputs to the EIP filter are previously predicted samples in the current block (1100). Referring to FIG. 13, all inputs to the EIP filter are predicted samples in the current block (1100), for example, for other positions in the current block (1100), the inputs to the EIP filter may include previously predicted samples in the current block (1100).

To reduce the prediction error, the searched min and max values may be applied to restrict the output range of each predicted value as described in Eq. 7.

$${pred}_{( x , y )} = clip ( min , max , ( {\sum }_{i = 0}^{n} ( {c}_{i} \times ( {t}_{( x - xoffset \_ i , y - yoffset \_ i )} - mean ) ) ) + mean ) \qquad Eq . 7$$

pred(x,y) is the predicted value at (x, y) in the current block (1100), min, max are searched min and max values from, for example, the reference area (1110) (e.g., the thirteen reconstructed columns and rows), ci represent the i^{th} coefficient of the derived EIP filter, t_{(x-xoffset_i,y-yoffset_i)} is reconstructed or a predicted value used to predict the current position or the current sample, and mean is a mean value calculated by the DC prediction mode.

Various partitioning may be applied in video/imaging coding, such as in VVC.

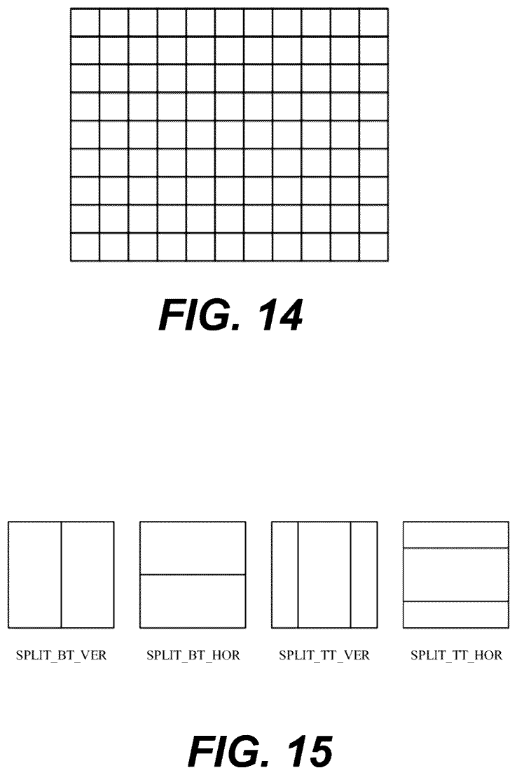

A picture may be partitioned into coding tree units (CTUs). For example, pictures are divided into a sequence of CTUs. The CTU concept in VVC may be the same as in HEVC. In some examples, for a picture that has three sample arrays, a CTU may consist of an N×N block of luma samples together with two corresponding blocks of chroma samples. FIG. 14 shows an example of a picture divided into CTUs.

In an example, the maximum allowed size of the luma block in a CTU is specified to be 128×128. In an example, the maximum size of the luma transform blocks is 64×64.

A CTU may be partitioned using a tree structure. In some examples, such as in HEVC, a CTU is split into CUs by using a quaternary-tree (QT) structure denoted as coding tree to adapt to various local characteristics. The decision whether to code a picture area using inter-picture (temporal) or intra-picture (spatial) prediction may be made at the leaf CU level. Each leaf CU may be further split into one, two or four PUs according to the PU splitting type. Inside one PU, the same prediction process may be applied and the relevant information may be transmitted to the decoder on a PU basis. After obtaining the residual block by applying the prediction process based on the PU splitting type, a leaf CU can be partitioned into transform units (TUs) according to another quaternary-tree structure similar to the coding tree for the CU. In an example, the HEVC structure has the multiple partition conceptions including CU, PU, and TU.

In some examples, such as in VVC, a quadtree with nested multi-type tree (MTT) using binary and ternary splits segmentation structure may replace the concepts of multiple partition unit types, e.g., the separation of the CU, PU and TU concepts may be removed except as needed for CUs that have a size too large for the maximum transform length, and supports more flexibility for CU partition shapes. In the coding tree structure, a CU can have a square or rectangular shape. A CTU may be first partitioned by a quaternary tree (also referred to as quadtree) structure. Then the quaternary tree leaf nodes can be further partitioned by a multi-type tree structure. FIG. 15 shows an example of multi-type tree splitting modes according to an aspect of the disclosure. A multi-type tree structure may include four splitting types: vertical binary splitting (SPLIT_BT_VER), horizontal binary splitting (SPLIT_BT_HOR), vertical ternary splitting (SPLIT_TT_VER), and horizontal ternary splitting (SPLIT_TT_HOR). The multi-type tree leaf nodes may be referred to as coding units (CUs), and unless the CU is too large for the maximum transform length, this segmentation (e.g., the CU) may be used for prediction and transform processing without any further partitioning. Thus, in most cases, the CU, PU and TU have the same block size in the quadtree with nested multi-type tree coding block structure. The exception may occur when the maximum supported transform length is smaller than the width or height of the color component of the CU.

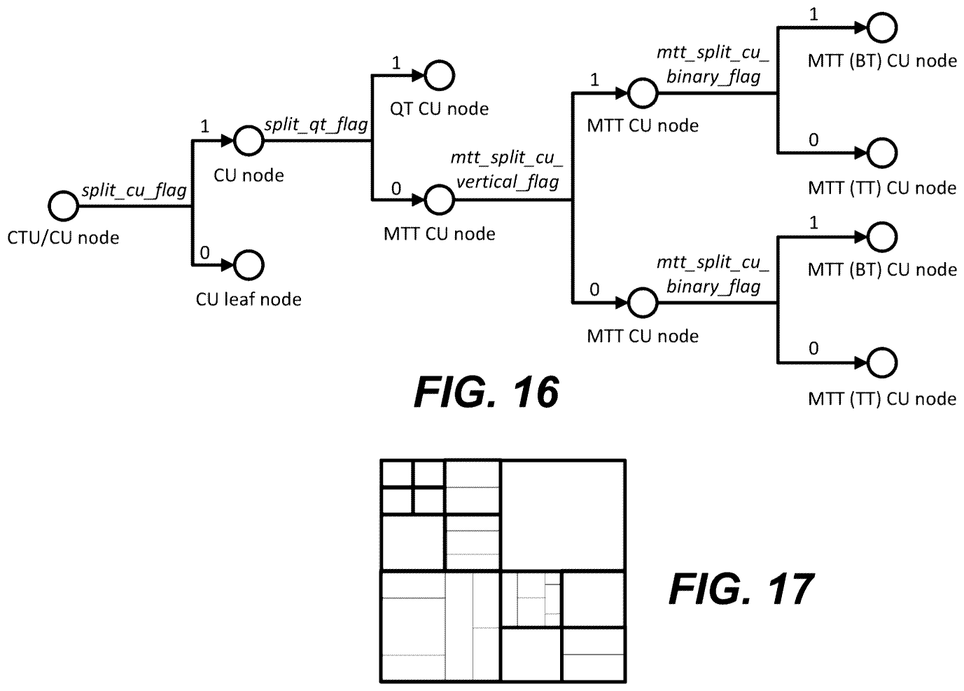

FIG. 16 shows an example of a signaling mechanism of the partition splitting information in a quadtree with nested multi-type tree coding tree structure according to an aspect of the disclosure. FIG. 16 shows examples of splitting flags signaling in quadtree with nested multi-type tree coding tree structure. A CTU may be treated as the root of a quaternary tree and may be first partitioned by a quaternary tree structure. Each quaternary tree leaf node (e.g., when sufficiently large to allow it) may be further partitioned by a multi-type tree structure. In the quadtree with nested multi-type tree coding tree structure, for each CU node, a first flag (split_cu_flag) may be signaled to indicate whether the node is further partitioned. If the current CU node is a quadtree CU node, a second flag (split_qt_flag) may be signaled to indicate whether the current CU node is further partitioned using a QT partitioning or MTT partitioning mode. When a node (e.g., the current CU node) is partitioned with MTT partitioning mode, a third flag (e.g., mtt_split_cu_vertical_flag) may be signaled to indicate the splitting direction, and then a fourth flag (e.g., mtt_split_cu_binary_flag) may be signaled to indicate whether the split is a binary split or a ternary split. Based on the values of mtt_split_cu_vertical_flag and mtt_split_cu_binary_flag, the multi-type tree slitting mode (MttSplitMode) of a CU may be derived as shown in Table 1.

TABLE 1
multi-type tree slitting mode (MttSplitMode) derviation
based on multi-type tree syntax elements

| | mtt_split_cu_{—} | mtt_split_cu_{—} |
|---|---|---|
| MttSplitMode | vertical_flag | binary_flag |
| SPLIT_TT_HOR | 0 | 0 |
| SPLIT_BT_HOR | 0 | 1 |
| SPLIT_TT_VER | 1 | 0 |
| SPLIT_BT_VER | 1 | 1 |

FIG. 17 shows an example of a CTU divided into multiple CUs with a quadtree and nested multi-type tree coding block structure according to an aspect of the disclosure. Referring to FIG. 17, the bold block edges represent quadtree partitioning and the remaining edges represent multi-type tree partitioning. The quadtree with nested multi-type tree partition may provide a content-adaptive coding tree structure including CUs. In an example, the size of the CU may be as large as the CTU or as small as 4×4 in units of luma samples. In an example, for the 4:2:0 chroma format, the maximum chroma CB size is 64×64 and the minimum size chroma CB consists of 16 chroma samples.

In an example such as in VVC, the maximum supported luma transform size may be 64×64 and the maximum supported chroma transform size may be 32×32. When the width or height of the CB is larger than the maximum transform width or height, the CB may be automatically split in the horizontal and/or vertical direction to meet the transform size restriction in the respective direction.

In an example such as VVC, the coding tree scheme may support the ability for the luma and chroma to have a separate block tree structure. For P and B slices, the luma and chroma CTBs in one CTU share the same coding tree structure. For I slices, the luma and chroma may have separate block tree structures. When the separate block tree mode is applied, a luma CTB may be partitioned into CUs by one coding tree structure, and the chroma CTBs may be partitioned into chroma CUs by another coding tree structure. Thus, a CU in a I slice may include, or consist of, a coding block of the luma component or coding blocks of two chroma components, and a CU in a P or B slice includes, or consists of, coding blocks of all three color components unless the video is monochrome.

Various adaptive block partitioning modes may be applied, such as in VVC. The adaptive block partitioning modes may adaptively select appropriate coding units based on a video content. As described above in FIGS. 9-10, multiple template shapes and filter shapes may be allowed to be used in the EIP mode. In some examples, the EIP mode does not take into account a size of the current block when selecting the template shape or the filter shape, and thus resulting in a large rate overhead to signal the selected template shape and filter shape. In an example, one syntax element is signaled to indicate the combination of the template shape and the filter shape. In an example, the combination of the template shape and the filter shape may be one of 9 modes.

Aspects of the disclosure provide techniques, apparatuses, and methods related to an adaptive mechanism that allows the selection of the template size, the template shape, and/or the filter shape based on the block size.

The methods, aspects, and examples described in the disclosure may be used separately or combined in any order. The term “the CCCM” may refer to the CCCM described in the disclosure or a variant. The term “the EIP mode” may refer to the EIP mode described in the disclosure or a variant. Further, the methods, aspects, and examples may be implemented by processing circuitry (e.g., one or more processors or one or more integrated circuits). In one example, the one or more processors execute a program that is stored in a non-transitory computer-readable medium.

Parameters w and h can represent a width and a height of a current block (or a subblock). A set of template types may include a first template type TPL0, a second template type TPL1, and a third template TPL 2. In an example, the first template type TPL0 includes, or consists of, neighboring reconstructed samples above the current block and to the left of the current block. In an example, the second template type TPL1 includes, or consists of, neighboring reconstructed samples above the current block. In an example, the third template type TPL2 includes, or consists of, neighboring reconstructed samples to the left of the current block. FIG. 9 shows an example of the set of template types {TPL0, TPL1, TPL2}. Referring to FIG. 9, the set of template types may include the three templates or template types referred as TPLi (i=0 to 2) from left to right, respectively. In an example, TPL0 has a shape that is similar or identical to the reference area (901), TPL1 has a shape that is similar or identical to the reference area (902), and TPL2 has a shape that is similar or identical to the reference area (903). In an example, the three reference areas (901)-(903) are referred to as TPL0 to TPL2.

A set of filter types may include a first filter type F0 with a number of input samples in a vertical direction that is equal to a number of the input samples in a horizontal direction, a second filter type F1 with a number of input samples in the horizontal direction that is greater than a number of the input samples in the vertical direction, and a third filter type F2 with a number of input samples in the vertical direction that is greater than a number of the input samples in the horizontal direction. FIG. 10 shows an example of the set of filter types {F0, F1, F2}. Referring to FIG. 10, the set of filter types may include the three filter types referred as Fi (i=0 to 2) from left to right, respectively. Fi (i=0 to 2) correspond to three filter shapes (1001)-(1003) in FIG. 10.

The set of template types (e.g., the three template types TPLi (i=0 to 2)) and the set of filter types (e.g., the three filter types Fi (i=0 to 2)) described above may be used in the EIP mode.

According to an aspect of the disclosure, the current block (or the current subblock) in a current picture is predicted according to the EIP mode. At least one of (i) one or more available template types from the set of template types (e.g., TPL0 to TPL2 as shown in FIG. 9) and (ii) one or more available filter types from the set of filter types (e.g., F0 to F2 as shown in FIG. 10) used in the EIP mode may be determined based on size information of the current block (or the current subblock) and at least one threshold value. A predicted value of a current sample in the current block (or the current subblock) may be determined according to the EIP mode with the at least one of (i) the one or more available template types and (ii) the one or more available filter types. The current sample may be reconstructed based on the predicted value of the current sample. In an example, the at least one threshold value is predefined or signaled in a high level syntax associated with a level that is higher than the current block. In an example, the at least one threshold value includes at least one of threshold values a-p, a′-p′, a″-h″, and a′″-h′″ described below.

In an aspect, the size information may include one of (i) the width w of the current block (or the current subblock), (ii) the height h of the current block (or the current subblock), (iii) an area w×h of the current block (or the current subblock), and (iv) a ratio between the width w and the height h indicating w/h of the current block (or the current subblock).

In an aspect, a block level decision may be applied to determine available template type(s) such as the one or more available template types based on the size information of the current block and a threshold value (e.g., one of the at least one threshold value). In an example, a subblock level decision may be applied to determine available template type(s) based on the size information of the current subblock and the threshold value.

In an aspect, the block level decision (or the subblock level decision) is determined (e.g., taken) based on the value of w, e.g., the width w of the current block (or the current subblock).
(i) In one example, if w is greater than (or equal to) some threshold (e.g., a threshold value a), a list of available templates (e.g., the one or more available template types) includes, or consists of, {TPL1}. Otherwise all the templates (e.g., {TPL0, TPL1, TPL2}) are available.
(ii) In another example, if w is greater than (or equal to) some threshold (e.g., a threshold value b), the list of available templates includes, or consists of, {TPL0}. Otherwise all the templates are available.
(iii) In another example, if w is greater than (or equal to) a threshold value c, the list of available templates includes, or consists of, {TPL0, TPL1}. Otherwise all the templates are available.
(iv) In another example, if w is less than (or equal to) a threshold value d, the list of available templates includes, or consists of, {TPL0}. Otherwise all the templates are available.
(v) In another example, if w is less than (or equal to) a threshold value e, the list of available templates includes, or consists of, {TPL0, TPL2}, otherwise all the templates are available.

As described above, in an example, the list of available templates (e.g., the one or more available template types) may be determined based on one of:
(i) the one or more available template types includes, or consists of, {TPL1} when w is greater than or equal to the threshold value a;
(ii) the one or more available template types includes, or consists of, {TPL0} when w is greater than or equal to the threshold value b;
(iii) the one or more available template types includes, or consists of, {TPL0, TPL1} when w is greater than or equal to the threshold value c;
(iv) the one or more available template types includes, or consists of, {TPL0} when w is less than or equal to the threshold value d; and
(v) the one or more available template types includes, or consists of, {TPL0, TPL2} when w is less than or equal to the threshold value e.

In an aspect, the block level decision (or the subblock level decision) is taken based on the value of h, e.g., the height h of the current block (or the current subblock).
(i) In one example, if h is greater than (or equal to) some threshold (e.g., a threshold value f), the list of available templates (e.g., the one or more available template types) includes, or consists of, {TPL2}. Otherwise all the templates (e.g., {TPL0, TPL1, TPL2}) are available.
(ii) In another example, if h is greater than (or equal to) some threshold (e.g., a threshold value g), the list of available templates includes, or consists of, {TPL0}. Otherwise all the templates are available.
(iii) In another example, if h is greater than (or equal to) a threshold value h, the list of available templates includes, or consists of, {TPL0, TPL2}. Otherwise all the templates are available.
(iv) In another example, if h is less than (or equal to) a threshold value i, the list of available templates includes, or consists of, {TPL0}. Otherwise all the templates are available.
(v) In another example, if h is less than (or equal to) a threshold value j, the list of available templates includes, or consists of, {TPL0, TPL1}. Otherwise all the templates are available.

As described above, in an example, the list of available templates (e.g., the one or more available template types) may be determined based on one of:
(i) the one or more available template types includes, or consists of, {TPL2} when h is greater than or equal to the threshold value f;
(ii) the one or more available template types includes, or consists of, {TPL0} when h is greater than or equal to the threshold value g;
(iii) the one or more available template types includes, or consists of, {TPL0, TPL2} when h is greater than or equal to the threshold value h;
(iv) the one or more available template types includes, or consists of, {TPL0} when h is less than or equal to the threshold value i; and
(v) the one or more available template types includes, or consists of, {TPL0, TPL1} when h is less than or equal to the threshold value j.

In an aspect, the block level decision (or the subblock level decision) is taken based on the value of w×h, e.g., the area w×h of the current block (or the current subblock).
(i) In one example, if w×h is greater than (or equal to) some threshold (e.g., a threshold value k), the list of available templates (e.g., the one or more available template types) includes, or consists of, {TPL0}. Otherwise all the templates (e.g., {TPL0, TPL1, TPL2}) are available.
(ii) In another example, if w×h is less than (or equal to) a threshold value l, the list of available templates includes, or consists of, {TPL0}. Otherwise all the templates are available.

As described above, in an example, the list of available templates (e.g., the one or more available template types) may be determined based on one of:
(i) the one or more available template types includes, or consists of, {TPL0} when w×h is greater than or equal to the threshold value k; and
(ii) the one or more available template types includes, or consists of, {TPL0} when w×h is less than or equal to the threshold value l.

In an aspect, the block level decision (or the subblock level decision) is taken based on the value of w/h of the current block (or the current subblock).
(i) In one example, if w/h is greater than (or equal to) some threshold (e.g., a threshold value m), the list of available templates (e.g., the one or more available template types) includes, or consists of, {TPL1}. Otherwise all the templates (e.g., {TPL0, TPL1, TPL2}) are available.
(ii) In another example, if w/h is greater than (or equal to) some threshold (e.g., a threshold value n), the list of available templates includes, or consists of, {TPL0, TPL1}. Otherwise all the templates are available.
(iii) In another example, if w/h is less than (or equal to) a threshold value o, the list of available templates includes, or consists of, {TPL2}. Otherwise all the templates are available.
(iv) In another example, if w/h is less than (or equal to) a threshold value p, the list of available templates includes, or consists of{TPL0, TPL2}. Otherwise all the templates are available.

As described above, the list of available templates (e.g., the one or more available template types) may be determined based on one of:
(i) the one or more available template types includes, or consists of, {TPL1} when w/h is greater than or equal to the threshold value m;
(ii) the one or more available template types includes, or consists of, {TPL0, TPL1} when w/h is greater than or equal to the threshold value n;
(iii) the one or more available template types includes, or consists of, {TPL2} when w/h is less than or equal to the threshold value o; and
(iv) the one or more available template types includes, or consists of, {TPL0, TPL2} when w/h is less than or equal to the threshold value p.

In an aspect, the threshold (e.g., the threshold values a-p) for each example may be different. For example, the threshold value a may be different from the threshold value d.

In an example, the threshold values a-p may be identical. In an example, one or more of the threshold values a-p may be different.

In an aspect, the threshold value (e.g., one of the threshold values a-p) may be a predefined value or may be signaled in the high level syntax including but not limited to a sequence parameter set (SPS), a picture parameter set (PPS), a picture header (PH), a slice header, or the like. In an example, the high level syntax is signaled in a level this is higher than a block level. For example, the high level syntax is associated with the level that is higher than the current block.

In an aspect, template types may be different based on respective template shapes, such as shown in FIG. 9, and the template types may correspond to the template shapes. In an example, a same template type may include templates with a same shape and different sizes.

TPLi may not be limited to the templates shown in FIG. 9. TPL0 may be related to a series of templates that may include, or consist of, the neighboring reconstructed samples on both sides (e.g., above and to the left) of the current block. TPL1 may be related to a series of templates that may include, or consist of, the neighboring reconstructed samples above the current block. TPL2 may be related to a series of templates that may include, or consist of, the neighboring reconstructed samples to the left of the current block.

In an example, templates with a same shape and different sizes may be considered as different template types.

In an aspect, multiple methods described above may be combined in any suitable manner. For example, the methods (ii) and (iv) of determining the list of available templates based on w/h may be combined. As described above, in the method (ii), if w/h is ≥the threshold value n, the list of available templates includes, or consists of, {TPL0, TPL1}, otherwise all the templates are available. In the method (iv), if w/h is ≤the threshold value p, the list of available templates includes, or consists of, {TPL0, TPL2}, otherwise all the templates are available. When multiple proposed methods are combined, the condition of the “if” statement has a higher priority than the “otherwise” statement. Thus, the combined methods (ii) and (iv) may include: if w/h is greater than (or equal to) a first threshold (e.g., the threshold value n), the list of available templates includes, or consists of, {TPL0, TPL1}; if w/h is less than (or equal to) the second threshold (e.g., the threshold value p), the list of available templates includes, or consists of, {TPL0, TPL2}; otherwise (e.g., w/h is between the second threshold and the first threshold) all the templates are available.

In an aspect, a block level decision may be applied to determine available filter type(s) (e.g., the one or more available filter types) based on the size information of the current block and a threshold value (e.g., one of the at least one threshold value). In an example, a subblock level decision may be applied to determine available filter type(s) based on the size information of the current subblock and the threshold value.

In an aspect, the block level decision (or the subblock level decision) is taken based on the value of w.
(i) In one example, if w is greater than (or equal to) some threshold (e.g., a threshold value a′), a list of available filter types (e.g., the one or more available filter types) such as a list of available filter shapes includes, or consists of, {F1}. Otherwise all the filter types (e.g., the filter shapes) such as {F0, F1, F2} are available.
(ii) In another example, if w is greater than (or equal to) some threshold (e.g., a threshold value b′), the list of available filter types such as the list of available filter shapes includes, or consists of, {F0}. Otherwise all the filter types (e.g., the filter shapes) are available.
(iii) In another example, if w is greater than (or equal to) a threshold value c′, the list of available filter types such as the list of available filter shapes includes, or consists of, {F0, F1}. Otherwise all the filter types (e.g., the filter shapes) are available.
(iv) In another example, if w is less than (or equal to) a threshold value d′, the list of available filter types such as the list of available filter shapes includes, or consists of, {F0}. Otherwise all the filter types (e.g., the filter shapes) are available.
(v) In another example, if w is less than (or equal to) a threshold value e′, the list of available filter types such as the list of available filter shapes includes, or consists of, {F0, F2}. Otherwise all the filter types (e.g., the filter shapes) are available.

As described above, in an example, the one or more available filter types (e.g., filter shapes) may be determined based on one of:
(i) the one or more available filter types includes, or consists of, {F1} when w is greater than or equal to the threshold value a′;
(ii) the one or more available filter types includes, or consists of, {F0} when w is greater than or equal to the threshold value b′;
(iii) the one or more available filter types includes, or consists of, {F0, F1} when w is greater than or equal to the threshold value c′;
(iv) the one or more available filter types includes, or consists of, {F0} when w is less than or equal to the threshold value d′; and
(v) the one or more available filter types includes, or consists of, {F0, F2} when w is less than or equal to the threshold value e′.

In an aspect, the block level decision (or the subblock level decision) is taken based on the value of h, e.g., the height h of the current block (or the current subblock).
(i) In one example, if h is greater than (or equal to) some threshold (e.g., a threshold value f′), the list of available filter types such as the list of available filter shapes (e.g., the one or more available filter types) includes, or consists of, {F2}. Otherwise all the filter types (e.g., {F0, F1, F2}) are available.
(ii) In another example, if h is greater than (or equal to) some threshold (e.g., a threshold value g′), the list of available filter types such as the list of available filter shapes includes, or consists of, {F0}. Otherwise all the filter types are available.
(iii) In another example, if h is greater than (or equal to) a threshold value h′, the list of available filter types such as the list of available filter shapes includes, or consists of, {F0, F2}. Otherwise all the filter types are available.
(iv) In another example, if h is less than (or equal to) a threshold value i′, the list of available filter types such as the list of available filter shapes includes, or consists of, {F0}. Otherwise all the filter types are available.
(v) In another example, if h is less than (or equal to) a threshold value j′, the list of available filter types such as the list of available filter shapes includes, or consists of, {F0, F1}. Otherwise all the filter types are available.

As described above, in an example, the list of available filter types (e.g., the one or more available filter types) may be determined based on one of:
(i) the one or more available filter types includes, or consists of, {F2} when h is greater than or equal to the threshold value f′;
(ii) the list of available filter types includes, or consists of, {F0} when h is greater than or equal to the threshold value g′;
(iii) the list of available filter types includes, or consists of, {F0, F2} when h is greater than or equal to the threshold value h′;
(iv) the list of available filter types includes, or consists of, {F0} when h is less than or equal to the threshold value i′; and
(v) the list of available filter types includes, or consists of, {F0, F1} when h is less than or equal to the threshold value j′.

In an aspect, the block level decision (or the subblock level decision) is taken based on the value of w×h, e.g., the area w×h of the current block (or the current subblock).
(i) In one example, if w×h is greater than (or equal to) some threshold (e.g., a threshold value k′), the list of available filter types such as the list of available filter shapes includes, or consists of, {F0}. Otherwise all the filter types (e.g., {F0, F1, F2}) are available.
(ii) In another example, if w×h is less than (or equal to) a threshold value l′, the list of available filter types such as the list of available filter shapes includes, or consists of, {F0}. Otherwise all the filter types are available.

As described above, in an example, the list of available filter types (e.g., the one or more available filter types) may be determined based on one of:
(i) the one or more available filter types includes, or consists of, {F0} when w×h is greater than or equal to the threshold value k′; and
(ii) the list of available filter types includes, or consists of, {F0} when w×h is less than or equal to the threshold value l′.

In an aspect, the block level decision (or the subblock level decision) is taken based on the value of w/h of the current block (or the current subblock).
(i) In one example, if w/h is greater than (or equal to) some threshold (e.g., a threshold value m′), the list of available filter types such as the list of available filter shapes includes, or consists of, {F1}. Otherwise all the filter types (e.g., {F0, F1, F2}) are available.
(ii) In another example, if w/h is greater than (or equal to) some threshold (e.g., a threshold value n′), the list of available filter types such as the list of available filter shapes includes, or consists of, {F0, F1}. Otherwise all the filter types are available.
(iii) In another example, if w/h is less than (or equal to) a threshold value o′, the list of available filter types such as the list of available filter shapes includes, or consists of, {F2}. Otherwise all the filter types are available.
(iv) In another example, if w/h is less than (or equal to) a threshold value p′, the list of available filter types such as the list of available filter shapes includes, or consists of, {F0, F2}. Otherwise all the filter types are available.

As described above, in an example, the list of available filter types (e.g., the one or more available filter types) may be determined based on one of:
(i) the one or more available filter types includes, or consists of, {F1} when w/h is greater than or equal to the threshold value m′;
(ii) the one or more available filter types includes, or consists of, {F0, F1} when w/h is greater than or equal to the threshold value n′;
(iii) the one or more available filter types includes, or consists of, {F2} when w/h is less than or equal to the threshold value o′; and
(iv) the one or more available filter types includes, or consists of, {F0, F2} when w/h is less than or equal to the threshold value p′.

In an aspect, the threshold (e.g., the threshold values a′-p′) for each example may be different. For example, the threshold value a′ may be different from the threshold value d′.

In an example, the threshold values a′-p′ may be identical. In an example, one or more of the threshold values a′-p′ may be different.

In an aspect, the threshold value (e.g., one of the threshold values a′-p′) may be a predefined value or may be signaled in the high level syntax including but not limited to the SPS, the PPS, the PH, the slice header, or the like, such as described above.

In an aspect, filter types may be different based on respective filter shapes, such as shown in FIG. 10, and the filter types may correspond to the filter shapes. In an example, a same filter type may include filters with a same shape and different sizes.

Fi may not be limited to the filter shapes shown in FIG. 10. F0 may be related to a series of filter types (e.g., filter shapes) whose number of the input samples in the vertical direction is equal to the one in the horizontal direction. In an example, F0 has a square shape. F1 may be related to a series of filter types (e.g., filter shapes) whose number of the input samples in the horizontal direction is greater than the one in the vertical direction. F2 may be related to a series of filter types (e.g., filter shapes) whose number of the input samples in the vertical direction is greater than the one in the horizontal direction. In an example, F1 and F2 have a rectangular shape.

In an example, filters with a same shape and different sizes may be considered as different filter types.

In an aspect, multiple methods described above may be combined in any suitable manner. For example, the methods (ii) and (iv) of determining the list of available filter types based on w/h may be combined, similarly as described above. When the multiple proposed methods are combined, the condition of the “if” statement has a higher priority than the “otherwise” statement, as described above. Thus, the combined methods (ii) and (iv) may include: if w/h is greater than (or equal to) a first threshold (e.g., the threshold value n′), the list of available filter types includes, or consists of, {F0, F1}; if w/h is less than (or equal to) the second threshold (e.g., the threshold value p′), the list of available filter types includes, or consists of, {F0, F2}; otherwise (e.g., w/h is between the second threshold and the first threshold) all the filter types are available.

In an aspect, the selected template type or the selected filter type may be signaled using context coding.

In an aspect, the selected template type (e.g., the template shape or the template size) may be signaled using context coding. The context modeling method may be determined (e.g., designed) based on the size information of the current block (or the current subblock) and a threshold value.

In an aspect, the block (subblock) level decision is taken based on the value of w. The context modeling may be determined (e.g., designed) based on the value of w.
(i) In one example, if w is greater than (or equal to) some threshold (e.g., a threshold value a″), a first context set (e.g., a context set 1) is used, otherwise a second context set (e.g., a context set 2) is used.
(ii) In another example, if w is less than (or equal to) a threshold value b″, the first context set (e.g., the context set 1) is used, otherwise the second context set (e.g., the context set 2) is used.

In an aspect, the block (subblock) level decision is taken based on the value of h. The context modeling may be determined (e.g., designed) based on the value of h.
(i) In one example, if h is greater than (or equal to) some threshold (e.g., a threshold value c″), the first context set (e.g., the context set 1) is used, otherwise the second context set (e.g., the context set 2) is used.
(ii) In another example, if h is less than (or equal to) a threshold value d″, the first context set (e.g., the context set 1) is used, otherwise the second context set (e.g., the context set 2) is used.

In an aspect, the block (subblock) level decision is taken based on the value of w×h. The context modeling may be determined (e.g., designed) based on the value of w×h.
(i) In one example, if w×h is greater than (or equal to) some threshold (e.g., a threshold value e″), the first context set (e.g., the context set 1) is used, otherwise the second context set (e.g., the context set 2) is used.
(ii) In another example, if w×h is less than (or equal to) a threshold value f′, the first context set (e.g., the context set 1) is used, otherwise the second context set (e.g., the context set 2) is used.

In an aspect, the block (subblock) level decision is taken based on the value of w/h. The context modeling may be determined (e.g., designed) based on the value of w/h.
(i) In one example, if w/h is greater than (or equal to) some threshold (e.g., a threshold value g″), the first context set (e.g., the context set 1) is used, otherwise the second context set (e.g., the context set 2) is used.
(ii) In another example, if w/h is less than (or equal to) a threshold value h″, the first context set (e.g., the context set 1) is used, otherwise the second context set (e.g., the context set 2) is used.

In an aspect, the threshold (e.g., the threshold values a″-h″) for each example may be different. For example, the threshold value a“may be different from the threshold value d”.

In an example, the threshold values a″-h″ may be identical. In an example, one or more of the threshold values a″-h″ may be different.

In an example, the first context set (e.g., the context set 1) or the second context set (e.g., the context set 2) used for each example can be different.

In an aspect, the threshold value (e.g., one of the threshold values a″-h″) used in determining the context modeling method for the selected template type may be a predefined value or may be signaled in the high level syntax including but not limited to the SPS, the PPS, the PH, the slice header, or the like, such as described above.

In an aspect, multiple methods described above may be combined in any suitable manner. For example, the methods (i) and (ii) of determining the context modeling for the template type based on w/h may be combined. When the multiple proposed methods are combined, the condition of the “if” statement has a higher priority than the “otherwise” statement, as described above. Thus, the combined methods (i) and (ii) may include: if w/h is greater than (or equal to) a first threshold, a context set 1 is used; if w/h is less than (or equal to) a second threshold, a context set 2 is used; otherwise, a context set 3 is used.

In an aspect, the selected filter type (e.g., the filter shape or the filter size) may be signaled using context coding. The context modeling method may be determined (e.g., designed) based on the size information of the current block (or the current subblock) and a threshold value.

In an aspect, the block (subblock) level decision is taken based on the value of w. The context modeling for the selected filter type may be determined (e.g., designed) based on the value of w.
(i) In one example, if w is greater than (or equal to) some threshold (e.g., a threshold value a′″), the first context set (e.g., the context set 1) is used, otherwise the second context set (e.g., the context set 2) is used.
(ii) In another example, if w is less than (or equal to) a threshold value b′″, the first context set (e.g., the context set 1) is used, otherwise the second context set (e.g., the context set 2) is used.

In an aspect, the block (subblock) level decision is taken based on the value of h. The context modeling for the selected filter type may be determined (e.g., designed) based on the value of h.
(i) In one example, if h is greater than (or equal to) some threshold (e.g., a threshold value c′″), the first context set (e.g., the context set 1) is used, otherwise the second context set (e.g., the context set 2) is used.
(ii) In another example, if h is less than (or equal to) a threshold value d′″, the first context set (e.g., the context set 1) is used, otherwise the second context set (e.g., the context set 2) is used.

In an aspect, the block (subblock) level decision is taken based on the value of w×h. The context modeling for the selected filter type may be determined (e.g., designed) based on the value of w×h.
(i) In one example, if w×h is greater than (or equal to) some threshold (e.g., a threshold value e′″), the first context set (e.g., the context set 1) is used, otherwise the second context set (e.g., the context set 2) is used.
(ii) In another example, if w×h is less than (or equal to) a threshold value f′″, the first context set (e.g., the context set 1) is used, otherwise the second context set (e.g., the context set 2) is used.

In an aspect, the block (subblock) level decision is taken based on the value of w/h. The context modeling for the selected filter type may be determined (e.g., designed) based on the value of w/h.
(i) In one example, if w/h is greater than (or equal to) some threshold (e.g., a threshold value g′″), the first context set (e.g., the context set 1) is used, otherwise the second context set (e.g., the context set 2) is used.
(ii) In another example, if w/h is less than (or equal to) a threshold value h′″, the first context set (e.g., the context set 1) is used, otherwise the second context set (e.g., the context set 2) is used.

In an example, the threshold values a′″-h′″ may be identical. In an example, one or more of the threshold values a′″-h′″ may be different.

In an example, the first context set (e.g., the context set 1) or the second context set (e.g., the context set 2) used for each example can be different.

In an aspect, the threshold value (e.g., one of the threshold values a′″-h′″) used in determining the context modeling method for the selected filter type may be a predefined value or may be signaled in the high level syntax including but not limited to the SPS, the PPS, the PH, the slice header, or the like, such as described above.

In an aspect, multiple methods described above may be combined in any suitable manner. For example, the methods (i) and (ii) of determining the context modeling for the selected filter type based on w/h may be combined. When multiple proposed methods are combined, the condition of the “if” statement has a higher priority than the “otherwise” statement, as described above. Thus, the combined methods (i) and (ii) may include: if w/h is greater than (or equal to) a first threshold, a context set 1 is used; if w/h is less than (or equal to) a second threshold, a context set 2 is used; otherwise, a context set 3 is used.

The methods, aspects, and examples in the disclosure may be combined. In an aspect, the one or more available template types (e.g., the one or more available template shapes) and the one or more available filter types (e.g., the one or more available filter shapes) of the current block are determined based on the size information, for example, the one or more available template types of the current block may be determined based on first size information (e.g., w, h, w×h, or w/h) and a threshold value (e.g., one of the threshold values a-p), and the one or more available filter types of the current block may be determined based on second size information (e.g., w, h, w×h, or w/h) and a threshold value (e.g., one of the threshold values a′-p′). The first size information may be identical to or different from the second size information.

In an aspect, the one or more available template types of the current block are determined based on the size information and one of the threshold values a-p. A filter type (e.g., a filter shape) of the current block is signaled and decoded using the context modeling described above.

In an aspect, the one or more available filter types of the current block are determined based on the size information and one of the threshold values a′-p′. A template type (e.g., a template shape) of the current block is signaled and decoded using the context modeling described above.

The methods, aspects, and examples in the disclosure can be applied at the block level or the subblock level. In an example, a block may be divided into multiple subblocks. The EIP may be applied to each subblock, and each subblock may share the same information such as the template type, the template size, the filter type, the filter size, and/or the like.

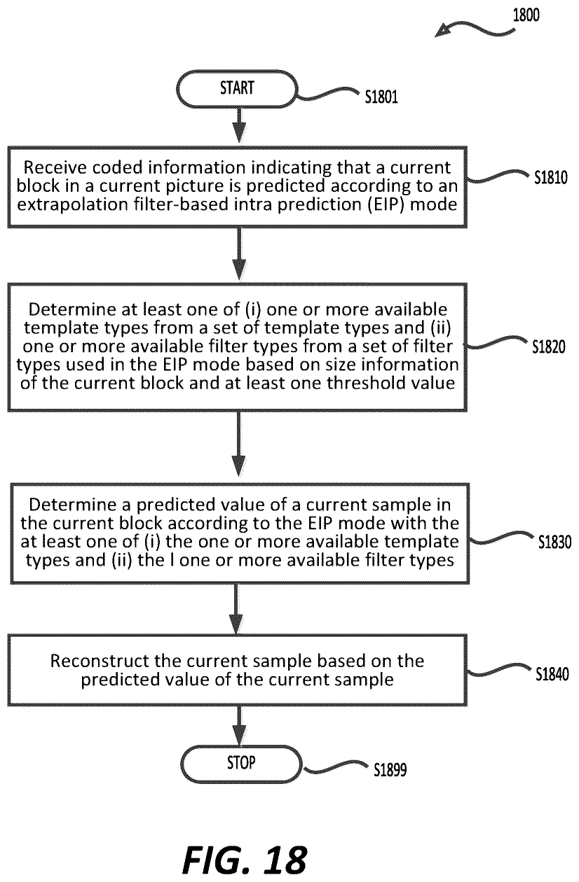

FIG. 18 shows a flow chart outlining a process (1800) according to an aspect of the disclosure. The process (1800) can be used in an apparatus, such as a video decoder. In various aspects, the process (1800) is executed by processing circuitry, such as the processing circuitry that performs functions of the video decoder (110), the processing circuitry that performs functions of the video decoder (210), and the like. In some aspects, the process (1800) is implemented in software instructions, thus when the processing circuitry executes the software instructions, the processing circuitry performs the process (1800). The process starts at (S1801) and proceeds to (S1810).

At (S1810), coded information indicating that a current block in a current picture is predicted according to an extrapolation filter-based intra prediction (EIP) mode is received.

At (S1820), at least one of (i) one or more available template types from a set of template types and (ii) one or more available filter types from a set of filter types used in the EIP mode is determined based on size information of the current block and at least one threshold value.

In an example, the at least one threshold value is predefined or signaled in a high level syntax associated with a level that is higher than the current block.

In an example, the size information includes one of (i) a width w of the current block; (ii) a height h of the current block; (iii) an area w×h of the current block; (iv) a ratio between the width w and the height h indicating w/h of the current block.

The set of template types includes a first template type TPL0 consisting of neighboring reconstructed samples above the current block and to the left of the current block, a second template type TPL1 consisting of neighboring reconstructed samples above the current block, and a third template type TPL2 consisting of neighboring reconstructed samples to the left of the current block.

In an aspect, the size information includes the width w of the current block. The at least one threshold value includes a threshold value. The one or more available template types is determined based on one of:
(i) the one or more available template types includes, or consists of, {TPL1} when w is greater than or equal to the threshold value;
(ii) the one or more available template types includes, or consists of, {TPL0} when w is greater than or equal to the threshold value;
(iii) the one or more available template types includes, or consists of, {TPL0, TPL1} when w is greater than or equal to the threshold value;
(iv) the one or more available template types includes, or consists of, {TPL0} when w is less than or equal to the threshold value; and
(v) the one or more available template types includes, or consists of, {TPL0, TPL2} when w is less than or equal to the threshold value.

In an aspect, the size information includes the height h of the current block. The at least one threshold value includes a threshold value. The one or more available template types is determined based on one of:
(i) the one or more available template types includes, or consists of, {TPL2}, when h is greater than or equal to the threshold value;
(ii) the one or more available template types includes, or consists of, {TPL0} when h is greater than or equal to the threshold value;
(iii) the one or more available template types includes, or consists of, {TPL0, TPL2} when h is greater than or equal to the threshold value;
(iv) the one or more available template types includes, or consists of, {TPL0} when h is less than or equal to the threshold value; and
(v) the one or more available template types includes, or consists of, {TPL0, TPL1} when h is less than or equal to the threshold value.

In an aspect, the size information includes the area w×h of the current block. The at least one threshold value includes a threshold value. The one or more available template types is determined based on one of:
(i) the one or more available template types includes, or consists of, {TPL0} when w×h is greater than or equal to the threshold value; and
(ii) the one or more available template types includes, or consists of, {TPL0} when w×h is less than or equal to the threshold value.

In an example, the size information includes the ratio between the width w and the height h indicating w/h. The at least one threshold value includes a threshold value. The one or more available template types is determined based on one of:
(i) the one or more available template types includes, or consists of, {TPL1} when w/h is greater than or equal to the threshold value;
(ii) the one or more available template types includes, or consists of, {TPL0, TPL1} when w/h is greater than or equal to the threshold value;
(iii) the one or more available template types includes, or consists of, {TPL0, TPL2} when w/h is less than or equal to the threshold value; and
(iv) the one or more available template types includes, or consists of, {TPL0, TPL2} when w/h is less than or equal to the threshold value.

In an aspect, the set of filter types includes a first filter type F0 with a number of input samples in a vertical direction that is equal to a number of the input samples in a horizontal direction, a second filter type F1 with a number of input samples in the horizontal direction that is greater than a number of the input samples in the vertical direction, and a third filter type F2 with a number of input samples in the vertical direction that is greater than a number of the input samples in the horizontal direction.

In an aspect, the size information includes the width w of the current block. The at least one threshold value includes a threshold value. The one or more available filter types is determined based on one of:
(i) the one or more available filter types includes, or consists of, {F1} when w is greater than or equal to the threshold value;
(ii) the one or more available filter types includes, or consists of, {F0} when w is greater than or equal to the threshold value;
(iii) the one or more available filter types includes, or consists of, {F0, F1} when w is greater than or equal to the threshold value;
(iv) the one or more available filter types includes, or consists of, {F0} when w is less than or equal to the threshold value; and
(v) the one or more available filter types includes, or consists of, {F0, F2} when w is less than or equal to the threshold value.

In an aspect, the size information includes the height h of the current block. The at least one threshold value includes a threshold value. The one or more available filter types is determined based on one of:
(i) the one or more available filter types includes, or consists of, {F2} when h is greater than or equal to the threshold value;
(ii) the one or more available filter types includes, or consists of, {F0}, when h is greater than or equal to the threshold value;
(iii) the one or more available filter types includes, or consists of, {F0, F2}, when h is greater than or equal to the threshold value;
(iv) the one or more available filter types includes, or consists of, {F0} when h is less than or equal to the threshold value; and
(v) the one or more available filter types includes, or consists of, {F0, F1} when h is less than or equal to the threshold value.

In an aspect, the size information includes the area w×h of the current block. The at least one threshold value includes a threshold value. The one or more available filter types is determined based on one of:
(i) the one or more available filter types includes, or consists of, {F0} when w×h is greater than or equal to the threshold value; and
(ii) the one or more available filter types includes, or consists of, {F0} when w×h is less than or equal to the threshold value.

In an aspect, the size information includes the ratio between the width w and the height h indicating w/h. The at least one threshold value includes a threshold value. The one or more available filter types is determined based on one of:
(i) the one or more available filter types includes, or consists of, {F1} when w/h is greater than or equal to the threshold value;
(ii) the one or more available filter types includes, or consists of, {F0, F1} when w/h is greater than or equal to the threshold value;
(iii) the one or more available filter types includes, or consists of, {F0, F2} when w/h is less than or equal to the threshold value; and
(iv) the one or more available filter types includes, or consists of, {F0, F2} when w/h is less than or equal to the threshold value.

At (S1830), a predicted value of a current sample in the current block is determined according to the EIP mode with the at least one of (i) the one or more available template types and (ii) the one or more available filter types.

At (S1840), the current sample is reconstructed based on the predicted value of the current sample.

Then, the process proceeds to (S1899) and terminates.

The process (1800) can be suitably adapted. Step(s) in the process (1800) can be modified and/or omitted. Additional step(s) can be added. Any suitable order of implementation can be used.

In an example, the at least one of (i) the one or more available template types and
(ii) the one or more available filter types includes (i) the one or more available template types and (ii) the one or more available filter types of the EIP mode. The size information includes first size information and second size information. The at least one threshold value includes a first threshold value and a second threshold value. The one or more available template types is determined based on the first size information of the current block and the first threshold value. The one or more available filter types is determined based on the second size information of the current block and the second threshold value.

The methods, aspects, and examples in the disclosure may be combined.

In an aspect, the one or more available template types of the current block are determined based on the size information and one of the threshold values a-p. A filter type (e.g., a filter shape) of the current block is signaled and decoded using the context modeling described above.

In an example, when the at least one of (i) the one or more available template types and (ii) the one or more available filter types includes, or consists of, the one or more available template types, context modeling used in context coding of a filter type selected for the current block is determined using second size information of the current block and at least one second threshold value.

The filter type may be decoded from the coded information based on the determined context modeling. The predicted value of the current sample may be determined using the EIP mode with the one or more available template types and the decoded filter type.

In an aspect, the one or more available filter types of the current block are determined based on the size information and one of the threshold values a′-p′. A template type (e.g., a template shape) of the current block is signaled and decoded using the context modeling described above.

In an example, when the at least one of (i) the one or more available template types and (ii) the one or more available filter types includes, or consists of, the one or more available filter types, context modeling used in context coding of a template type selected for the current block may be determined using second size information of the current block and at least one second threshold value. The template type may be decoded from the coded information based on the determined context modeling. The predicted value of the current sample may be determined using the EIP mode with the decoded template type and the one or more available filter types.

In an example, the at least one second threshold value is predefined or signaled in a high level syntax associated with a level that is higher than the current block.

In an example, the second size information used to determine the context modeling includes one of (i) the width w of the current block; (ii) the height h of the current block; (iii) the area w×h of the current block; (iv) the ratio between the width w and the height h indicating w/h. The context modeling is one of a first context set and a second context set.

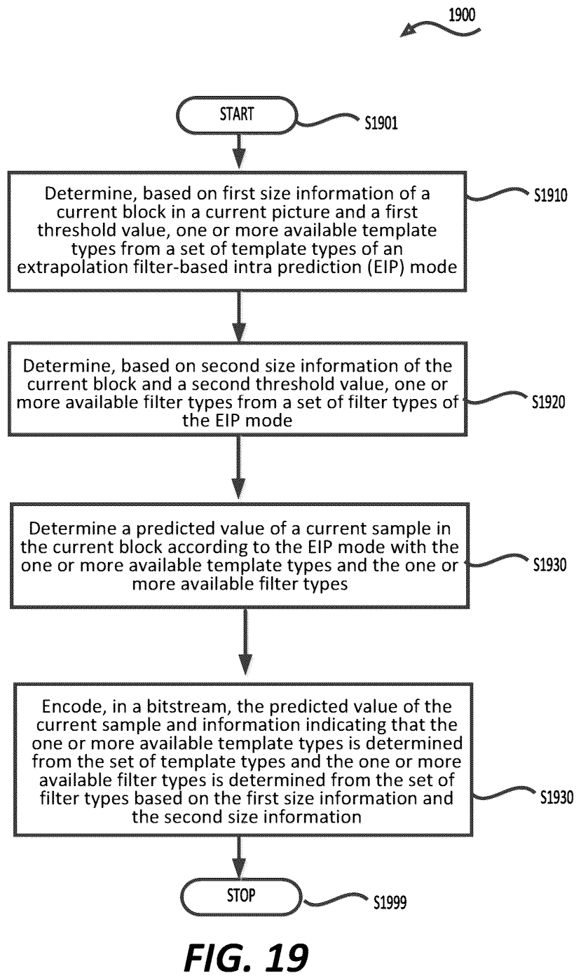

FIG. 19 shows a flow chart outlining a process (1900) according to an aspect of the disclosure. The process (1900) can be used in a video encoder. In various aspects, the process (1900) is executed by processing circuitry, such as the processing circuitry that performs functions of the video encoder (103), the processing circuitry that performs functions of the video encoder (303), and the like. In some aspects, the process (1900) is implemented in software instructions, thus when the processing circuitry executes the software instructions, the processing circuitry performs the process (1900). The process starts at (S1901) and proceeds to (S1910).

At (S1910), one or more available template types for a current block in a current picture is determined from a set of template types of an extrapolation filter-based intra prediction (EIP) mode based on first size information of the current block and a first threshold value. The current block is predicted using the EIP mode.

At (S1920), one or more available filter types is determined from a set of filter types of the EIP mode based on second size information of the current block and a second threshold value.

At (S1930), a predicted value of a current sample in the current block is determined according to the EIP mode with the one or more available template types and the one or more available filter types.

At (S1940), the predicted value of the current sample and information indicating that the one or more available template types is determined from the set of template types and the one or more available filter types is determined from the set of filter types based on the first size information and the second size information can be encoded in a bitstream.

Then, the process proceeds to (S1999) and terminates.

The process (1900) can be suitably adapted. Step(s) in the process (1900) can be modified and/or omitted. Additional step(s) can be added. Any suitable order of implementation can be used.

In an example, the first threshold value and the second threshold value are predefined or encoded in a high level syntax associated with a level that is higher than the current block.

In an example, the first size information or the second size information includes one of (i) a width w of the current block; (ii) a height h of the current block; (iii) an area w×h of the current block; (iv) a ratio between the width w and the height h indicating w/h.

In an example, the set of template types includes a first template type TPL0 consisting of neighboring reconstructed samples above the current block and to the left of the current block, a second template type TPL1 consisting of neighboring reconstructed samples above the current block, and a third template type TPL2 consisting of neighboring reconstructed samples to the left of the current block. In an example, the set of filter types includes a first filter type F0 with a number of input samples in a vertical direction that is equal to a number of the input samples in a horizontal direction, a second filter type F1 with a number of input samples in the horizontal direction that is greater than a number of the input samples in the vertical direction, and a third filter type F2 with a number of input samples in the vertical direction that is greater than a number of the input samples in the horizontal direction.

In an aspect, a method of processing visual media data includes processing a bitstream of visual media data according to a format rule. The bitstream includes at least one syntax element indicating that (i) a current block in a current picture is predicted according to an extrapolation filter-based intra prediction (EIP) mode and (ii) one or more available template types of the EIP mode is determined (e.g., selected) from a set of template types and one or more available filter types of the EIP mode is determined (e.g., selected) from a set of filter types based on first size information and second size information of the current block. The bitstream includes at least one high level syntax element associated with a level that is higher than the current block indicating a first threshold value and a second threshold value. The format rule specifies that the one or more available template types is determined based on the first size information of the current block and the first threshold value from the set of template types. The format rule specifies that the one or more available filter types is determined based on the second size information of the current block and the second threshold value from the set of filter types. The format rule specifies that a predicted value of a current sample in the current block is determined according to the EIP mode with the one or more available template types and the one or more available filter types.

In an example, the first size information or the second size information includes one of (i) a width w of the current block; (ii) a height h of the current block; (iii) an area w×h of the current block; (iv) a ratio between the width w and the height h indicating w/h. The set of template types includes a first template type TPL0 consisting of neighboring reconstructed samples above the current block and to the left of the current block, a second template type TPL1 consisting of neighboring reconstructed samples above the current block, and a third template type TPL2 consisting of neighboring reconstructed samples to the left of the current block. The set of filter types includes a first filter type F0 with a number of input samples in a vertical direction that is equal to a number of the input samples in a horizontal direction, a second filter type F1 with a number of input samples in the horizontal direction that is greater than a number of the input samples in the vertical direction, and a third filter type F2 with a number of input samples in the vertical direction that is greater than a number of the input samples in the horizontal direction.

Aspects and/or examples in the disclosure may be used separately or combined in any order. For example, some aspects and/or examples performed by the decoder may be performed by the encoder and vice versa. Each of the methods (or aspects), an encoder, and a decoder may be implemented by processing circuitry (e.g., one or more processors or one or more integrated circuits). In one example, the one or more processors execute a program that is stored in a non-transitory computer-readable medium.

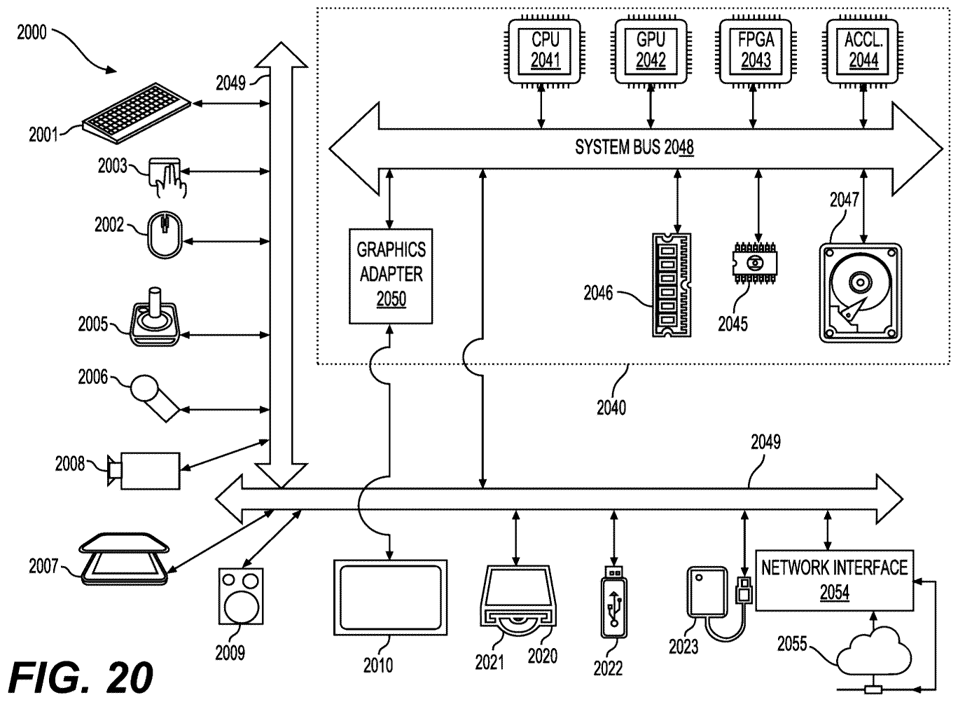

The techniques described above, can be implemented as computer software using computer-readable instructions and physically stored in one or more computer-readable media. For example, FIG. 20 shows a computer system (2000) suitable for implementing certain aspects of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 20 for computer system (2000) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of a computer system (2000).

Computer system (2000) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (2001), mouse (2002), trackpad (2003), touch screen (2010), data-glove (not shown), joystick (2005), microphone (2006), scanner (2007), camera (2008).

Computer system (2000) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (2010), data-glove (not shown), or joystick (2005), but there can also be tactile feedback devices that do not serve as input devices), audio output devices (such as: speakers (2009), headphones (not depicted)), visual output devices (such as screens (2010) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (2000) can also include human accessible storage devices and their associated media such as optical media including CD/DVD ROM/RW (2020) with CD/DVD or the like media (2021), thumb-drive (2022), removable hard drive or solid state drive (2023), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (2000) can also include an interface (2054) to one or more communication networks (2055). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (2049) (such as, for example USB ports of the computer system (2000)); others are commonly integrated into the core of the computer system (2000) by attachment to a system bus as described below (for example Ethernet interface into a PC computer system or cellular network interface into a smartphone computer system). Using any of these networks, computer system (2000) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (2040) of the computer system (2000).

The core (2040) can include one or more Central Processing Units (CPU) (2041), Graphics Processing Units (GPU) (2042), specialized programmable processing units in the form of Field Programmable Gate Areas (FPGA) (2043), hardware accelerators for certain tasks (2044), graphics adapters (2050), and so forth. These devices, along with Read-only memory (ROM) (2045), Random-access memory (2046), internal mass storage such as internal non-user accessible hard drives, SSDs, and the like (2047), may be connected through a system bus (2048). In some computer systems, the system bus (2048) can be accessible in the form of one or more physical plugs to enable extensions by additional CPUs, GPU, and the like. The peripheral devices can be attached either directly to the core's system bus (2048), or through a peripheral bus (2049). In an example, the screen (2010) can be connected to the graphics adapter (2050). Architectures for a peripheral bus include PCI, USB, and the like.

CPUs (2041), GPUs (2042), FPGAs (2043), and accelerators (2044) can execute certain instructions that, in combination, can make up the aforementioned computer code. That computer code can be stored in ROM (2045) or RAM (2046). Transitional data can also be stored in RAM (2046), whereas permanent data can be stored for example, in the internal mass storage (2047). Fast storage and retrieve to any of the memory devices can be enabled through the use of cache memory, that can be closely associated with one or more CPU (2041), GPU (2042), mass storage (2047), ROM (2045), RAM (2046), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (2000), and specifically the core (2040) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (2040) that are of non-transitory nature, such as core-internal mass storage (2047) or ROM (2045). The software implementing various aspects of the present disclosure can be stored in such devices and executed by core (2040). A computer-readable medium can include one or more memory devices or chips, according to particular needs. The software can cause the core (2040) and specifically the processors therein (including CPU, GPU, FPGA, and the like) to execute particular processes or particular parts of particular processes described herein, including defining data structures stored in RAM (2046) and modifying such data structures according to the processes defined by the software. In addition or as an alternative, the computer system can provide functionality as a result of logic hardwired or otherwise embodied in a circuit (for example: accelerator (2044)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. An apparatus for video decoding, comprising:
processing circuitry configured to:
receive coded information indicating that a current block in a current picture is predicted according to an extrapolation filter-based intra prediction (EIP) mode;
determine at least one of (i) one or more available template types from a set of template types and (ii) one or more available filter types from a set of filter types used in the EIP mode based on size information of the current block and at least one threshold value;
determine a predicted value of a current sample in the current block according to the EIP mode with the at least one of (i) the one or more available template types and (ii) the one or more available filter types; and
reconstruct the current sample based on the predicted value of the current sample.

2. The apparatus of claim 1, wherein
the at least one of (i) the one or more available template types and (ii) the one or more available filter types includes the one or more available template types and the one or more available filter types of the EIP mode;
the size information includes first size information and second size information;
the at least one threshold value includes a first threshold value and a second threshold value; and
the processing circuitry is configured to:
determine the one or more available template types based on the first size information of the current block and the first threshold value; and
determine the one or more available filter types based on the second size information of the current block and the second threshold value.

3. The apparatus of claim 1, wherein the at least one threshold value is predefined or signaled in a high level syntax associated with a level that is higher than the current block.

4. The apparatus of claim 1, wherein
the size information comprises one of (i) a width w of the current block; (ii) a height h of the current block; (iii) an area w×h of the current block; (iv) a ratio between the width w and the height h indicating w/h of the current block; and
the set of template types includes a first template type TPL0 consisting of neighboring reconstructed samples above the current block and to the left of the current block, a second template type TPL1 consisting of neighboring reconstructed samples above the current block, and a third template type TPL2 consisting of neighboring reconstructed samples to the left of the current block.

5. The apparatus of claim 4, wherein
the size information comprises the width w of the current block;
the at least one threshold value includes a threshold value; and
the processing circuitry is configured to determine the one or more available template types based on one of:
(i) the one or more available template types consists of {TPL1} when w is greater than or equal to the threshold value;
(ii) the one or more available template types consists of {TPL0} when w is greater than or equal to the threshold value;
(iii) the one or more available template types consists of {TPL0, TPL1} when w is greater than or equal to the threshold value;
(iv) the one or more available template types consists of {TPL0} when w is less than or equal to the threshold value; and
(v) the one or more available template types consists of {TPL0, TPL2} when w is less than or equal to the threshold value.

6. The apparatus of claim 4, wherein
the size information comprises the height h of the current block;
the at least one threshold value includes a threshold value; and
the processing circuitry is configured to determine the one or more available template types based on one of:
(i) the one or more available template types consists of {TPL2}, when h is greater than or equal to the threshold value;
(ii) the one or more available template types consists of {TPL0} when h is greater than or equal to the threshold value;
(iii) the one or more available template types consists of {TPL0, TPL2} when h is greater than or equal to the threshold value;
(iv) the one or more available template types consists of {TPL0} when h is less than or equal to the threshold value; and
(v) the one or more available template types consists of {TPL0, TPL1} when h is less than or equal to the threshold value.

7. The apparatus of claim 4, wherein
the size information comprises the area w×h of the current block;
the at least one threshold value includes a threshold value; and
the processing circuitry is configured to determine the one or more available template types based on one of:
(i) the one or more available template types consists of {TPL0} when w×h is greater than or equal to the threshold value; and
(ii) the one or more available template types consists of {TPL0} when w×h is less than or equal to the threshold value.

8. The apparatus of claim 1, wherein
the size information comprises one of (i) a width w of the current block; (ii) a height h of the current block; (iii) an area w×h of the current block; (iv) a ratio between the width w and the height h indicating w/h; and
the set of filter types includes a first filter type F0 with a number of input samples in a vertical direction that is equal to a number of the input samples in a horizontal direction, a second filter type F1 with a number of input samples in the horizontal direction that is greater than a number of the input samples in the vertical direction, and a third filter type F2 with a number of input samples in the vertical direction that is greater than a number of the input samples in the horizontal direction.

9. The apparatus of claim 1, wherein the processing circuitry is configured to:
when the at least one of (i) the one or more available template types and (ii) the one or more available filter types consists of the one or more available template types,
determine, using second size information of the current block and at least one second threshold value, context modeling used in context coding of a filter type selected for the current block;
decode the filter type from the coded information based on the determined context modeling; and
determine the predicted value of the current sample using the EIP mode with the one or more available template types and the decoded filter type; and
when the at least one of (i) the one or more available template types and (ii) the one or more available filter types consists of the one or more available filter types,
determine, using second size information of the current block and at least one second threshold value, context modeling used in context coding of a template type selected for the current block;
decode the template type from the coded information based on the determined context modeling; and
determine the predicted value of the current sample using the EIP mode with the decoded template type and the one or more available filter types.

10. The apparatus of claim 9, wherein
the second size information used to determine the context modeling comprises one of (i) a width w of the current block; (ii) a height h of the current block; (iii) an area w×h of the current block; (iv) a ratio between the width w and the height h indicating w/h; and
the context modeling is one of a first context set and a second context set.

11. A method for video encoding, the method comprising:
determining at least one of (i) one or more available template types from a set of template types and (ii) one or more available filter types from a set of filter types used in an extrapolation filter-based intra prediction (EIP) mode based on size information of a current block in a current picture that is predicted according to the EIP mode and at least one threshold value;
determining a predicted value of a current sample in the current block according to the EIP mode with the at least one of (i) the one or more available template types and (ii) the one or more available filter types; and
encoding the current sample based on the predicted value of the current sample.

12. The method of claim 11, wherein
the at least one of (i) the one or more available template types and (ii) the one or more available filter types includes the one or more available template types and the one or more available filter types of the EIP mode;
the size information includes first size information and second size information;
the at least one threshold value includes a first threshold value and a second threshold value; and
the determining the at least one of (i) the one or more available template types and (ii) the one or more available filter types includes:
determining the one or more available template types based on the first size information of the current block and the first threshold value; and
determining the one or more available filter types based on the second size information of the current block and the second threshold value.

13. The method of claim 11, wherein the at least one threshold value is predefined or signaled in a high level syntax associated with a level that is higher than the current block.

14. The method of claim 11, wherein
the size information comprises one of (i) a width w of the current block; (ii) a height h of the current block; (iii) an area w×h of the current block; (iv) a ratio between the width w and the height h indicating w/h of the current block; and
the set of template types includes a first template type TPL0 consisting of neighboring reconstructed samples above the current block and to the left of the current block, a second template type TPL1 consisting of neighboring reconstructed samples above the current block, and a third template type TPL2 consisting of neighboring reconstructed samples to the left of the current block.

15. The method of claim 14, wherein
the size information comprises the width w of the current block;
the at least one threshold value includes a threshold value; and
the determining the one or more available template types includes determining the one or more available template types based on one of:
(i) the one or more available template types consists of {TPL1} when w is greater than or equal to the threshold value;
(ii) the one or more available template types consists of {TPL0} when w is greater than or equal to the threshold value;
(iii) the one or more available template types consists of {TPL0, TPL1} when w is greater than or equal to the threshold value;
(iv) the one or more available template types consists of {TPL0} when w is less than or equal to the threshold value; and
(v) the one or more available template types consists of {TPL0, TPL2} when w is less than or equal to the threshold value.

16. The method of claim 14, wherein
the size information comprises the height h of the current block;
the at least one threshold value includes a threshold value; and
the determining the one or more available template types includes determining the one or more available template types based on one of:
(i) the one or more available template types consists of {TPL2}, when h is greater than or equal to the threshold value;
(ii) the one or more available template types consists of {TPL0} when h is greater than or equal to the threshold value;
(iii) the one or more available template types consists of {TPL0, TPL2} when h is greater than or equal to the threshold value;
(iv) the one or more available template types consists of {TPL0} when h is less than or equal to the threshold value; and
(v) the one or more available template types consists of {TPL0, TPL1} when h is less than or equal to the threshold value.

17. The method of claim 14, wherein
the size information comprises the area w×h of the current block;
the at least one threshold value includes a threshold value; and
the determining the one or more available template types includes determining the one or more available template types based on one of:
(i) the one or more available template types consists of {TPL0} when w×h is greater than or equal to the threshold value; and
(ii) the one or more available template types consists of {TPL0} when w×h is less than or equal to the threshold value.

18. The method of claim 11, wherein
the size information comprises one of (i) a width w of the current block; (ii) a height h of the current block; (iii) an area w×h of the current block; (iv) a ratio between the width w and the height h indicating w/h; and
the set of filter types includes a first filter type F0 with a number of input samples in a vertical direction that is equal to a number of the input samples in a horizontal direction, a second filter type F1 with a number of input samples in the horizontal direction that is greater than a number of the input samples in the vertical direction, and a third filter type F2 with a number of input samples in the vertical direction that is greater than a number of the input samples in the horizontal direction.

19. A non-transitory computer readable medium storing a video media bitstream encoded by an encoding method, the encoding method comprising:
determining at least one of (i) one or more available template types from a set of template types and (ii) one or more available filter types from a set of filter types used in an extrapolation filter-based intra prediction (EIP) mode based on size information of a current block in a current picture that is predicted according to the EIP mode and at least one threshold value;
determining a predicted value of a current sample in the current block according to the EIP mode with the at least one of (i) the one or more available template types and (ii) the one or more available filter types; and
encoding the current sample based on the predicted value of the current sample.

20. The method of claim 19, wherein
the at least one of (i) the one or more available template types and (ii) the one or more available filter types includes the one or more available template types and the one or more available filter types of the EIP mode;
the size information includes first size information and second size information;
the at least one threshold value includes a first threshold value and a second threshold value; and
the determining the at least one of (i) the one or more available template types and (ii) the one or more available filter types includes:
determining the one or more available template types based on the first size information of the current block and the first threshold value; and
determining the one or more available filter types based on the second size information of the current block and the second threshold value.
